(19) United States
(12) Patent Application Publication
(10) Pub. No.: US 2023/0085455 A1
(43) Pub. Date: Mar. 16, 2023

(54) VEHICLE CONDITION ESTIMATION METHOD, VEHICLE CONDITION ESTIMATION DEVICE, AND VEHICLE CONDITION ESTIMATION PROGRAM

(71) Applicant: NIPPON TELEGRAPH AND TELEPHONE CORPORATION, Tokyo (JP)

(72) Inventors: Kohei MORI, Tokyo (JP); Takahiro HATA, Tokyo (JP); Yuki YOKOHATA, Tokyo (JP); Kazuaki OBANA, Tokyo (JP)

(73) Assignee: NIPPON TELEGRAPH AND TELEPHONE CORPORATION, Tokyo (JP)

(21) Appl. No.: 17/799,636

(22) PCT Filed: Feb. 20, 2020
(86) PCT No.: PCT/JP2020/006829

§ 371 Date: Aug. 12, 2022

(51) Int. Cl. G06V 20/56; B60W 40/02

(52) U.S. Cl. CPC G06V 20/588; B60W 40/02; B60W 2420/42; B60W 2554/80

(57) ABSTRACT

A vehicle condition estimation method performed by an information processing device including a processor and a memory connected to the processor to estimate a position or a condition of a vehicle, includes: acquiring an image including a vehicle to be estimated; and estimating the position or the condition of the vehicle to be estimated, using a line segment connecting at least two points selected from a region in which the vehicle to be estimated is captured in the image, with reference to an imaging device that has captured the image.

### TECHNICAL FIELD

Techniques disclosed herein relate to a vehicle condition estimation method, a vehicle condition estimation device, and a vehicle condition estimation program.

### BACKGROUND ART

Techniques related to, for example, car cruise control or driving support have been actively developed. NPL 1 states techniques related to car cruise control or driving support. In such techniques, it is highly important to integrate information and conditions of vehicles other than a host vehicle (hereinafter, referred to as “surrounding vehicles”), the information and condition including which lanes on which surrounding vehicles are traveling, and a speed in kilometers per hour and the directions in which vehicles are traveling, to accurately recognize traffic flows in each of the lanes in order to safely control the traveling of the host vehicle.

### CITATION LIST

### Non Patent Literature

NPL 1: Study Group Focusing on Realization of Connected Car Society, “For Realization of Connected Car Society”, Jul. 13, 2017

### SUMMARY OF THE INVENTION

### Technical Problem

For car cruise control or driving support, conditions of vehicles surrounding a host vehicle need to be recognized. In the technique for recognizing the conditions of the surrounding vehicles through inter-vehicle communication, vehicles surrounding the host vehicle need to be equipped with equipment compatible with the technique and sufficient performance cannot be achieved depending on the degree of distribution of such equipment. Further, for the purpose of supporting local driving, it is sufficient to recognize positional relationships between the host vehicle and vehicles surrounding the host vehicle, and accumulating and analyzing data via a network are synonymous with transmitting and calculating more information than necessary.

The disclosed technique has been made in view of the above points, and an object thereof is to provide a vehicle condition estimation method, a vehicle condition estimation device, and a vehicle condition estimation program capable of estimating relationships between a host vehicle and surrounding vehicles and conditions of the surrounding vehicles without using any special equipment.

### Means for Solving the Problem

According to a first aspect of the present disclosure, there is provided a vehicle condition estimation method performed by an information processing device including a processor and a memory connected to the processor to estimate a position or a condition of a vehicle. The method includes: acquiring an image including a vehicle to be estimated; and estimating the position or the condition of the vehicle to be estimated with reference to an imaging device that has captured the image using a line segment connecting at least two points selected from a region in which the vehicle to be estimated is captured in the image.

According to a second aspect of the present disclosure, there is provided a vehicle condition estimation device for estimating a position or a condition of a vehicle, the device including: an image acquisition section configured to acquire an image of a vehicle to be estimated; and a surrounding-vehicle condition estimation section configured to estimate the position or the condition of the vehicle to be estimated with reference to an imaging device that has captured the image using a line segment connecting at least two points selected from a region in which the vehicle to be estimated is captured in the image.

According to a third aspect of the present disclosure, there is provided a vehicle condition estimation program that causes a computer to estimate a position or a condition of a vehicle, the program causing the computer to execute processing of: acquiring an image of a vehicle to be estimated; and estimating the position or the condition of the vehicle to be estimated with reference to an imaging device that has captured the image using a line segment connecting at least two points selected from a region in which the vehicle to be estimated has been captured in the image.

### Effects of the Invention

The disclosed technique can provide a vehicle condition estimation device, a vehicle condition estimation method, and a vehicle condition estimation program capable of estimating conditions of surrounding vehicles without obtaining information from surrounding vehicles and without using any special equipment, by analyzing an image of a vehicle to be estimated, the image being captured from a known position.

### BRIEF DESCRIPTION OF DRAWINGS

FIG. 1A illustrates a schematic configuration of a vehicle condition estimation system including a vehicle condition estimation device according to a first embodiment and a second embodiment.

FIG. 1B illustrates a schematic configuration of a vehicle condition estimation system including a vehicle condition estimation device according to a third embodiment.

FIG. 2 is a block diagram illustrating a hardware configuration of the vehicle condition estimation device.

FIG. 3A is a block diagram illustrating an example of a functional configuration of the vehicle condition estimation device according to the first embodiment.

FIG. 3B is a block diagram illustrating an example of a functional configuration of the vehicle condition estimation device according to the second embodiment.

FIG. 3C is a block diagram illustrating an example of a functional configuration of the vehicle condition estimation device according to the third embodiment.

FIG. 4A is a flowchart illustrating a flow of vehicle condition estimation processing performed by the vehicle condition estimation device.

FIG. 4B is a flowchart illustrating a flow of vehicle condition estimation processing performed by the vehicle condition estimation device.

FIG. 4C is a flowchart illustrating a flow of vehicle condition estimation processing performed by the vehicle condition estimation device.

FIG. 5 is a diagram illustrating an example of the present embodiment.

FIG. 6 is a flowchart illustrating details of host-vehicle traveling lane estimation processing.

FIG. 7 is a diagram for explaining the host-vehicle traveling lane estimation processing.

FIG. 8A is a flowchart illustrating details of surrounding-vehicle condition estimation processing.

FIG. 8B is a flowchart illustrating details of surrounding-vehicle condition estimation processing.

FIG. 9A is a diagram illustrating an example in which a surrounding vehicle and lane marker lines are detected in certain image data.

FIG. 9B is a diagram illustrating an example in which a surrounding vehicle and lane marker lines are detected in certain image data.

FIG. 10 is a diagram illustrating coordinates of the lowermost portions of a front wheel and a rear wheel that are located on one side of a vehicle body of a surrounding vehicle.

FIG. 11 is a diagram illustrating an example of image data.

FIG. 12 is a diagram illustrating an example of image data.

FIG. 13 is a diagram illustrating a condition in which a vehicle condition estimation device including a camera located at a position of a sidewalk captures an image of a range including a road region.

FIG. 14 is a diagram illustrating an example of image data.

FIG. 15 is a diagram illustrating a special vehicle.

FIG. 16 is a diagram illustrating a special vehicle.

FIG. 17 is a diagram illustrating a special vehicle.

FIG. 18 is a diagram illustrating a special vehicle.

### DESCRIPTION OF EMBODIMENTS

Hereinafter, an example of embodiments of the techniques disclosed herein will be described with reference to the drawings. In the drawings, the same reference signs are used to the same or equivalent components and parts. The dimensional ratios in the drawings may be exaggerated for convenience of explanation and may differ from actual ratios.

First, an outline of the embodiments of the disclosed technique will be described.

Relative relationships between cars and absolute relationships between roads and cars are classified. The former relationships include, for example, a position of a second car relative to a first car, and a traveling direction of a second car relative to a traveling direction of a first car. The latter relationships include, for example, a speed, traveling lane, and traveling direction of a second car. Although the first car is assumed to be a host vehicle and the second car is assumed to be a surrounding vehicle in the embodiments described below, both the first car and the second car may be surrounding vehicles according to the disclosed technique. Note that a traffic flow of a road may be estimated based on the aforementioned relationships.

The disclosed technique, first, estimates, from the above image, a relative relationship between the second car (hereinafter, referred to as a “surrounding vehicle”) appearing in an image captured from the first car (hereinafter, referred to as a “host vehicle”) and the host vehicle. More specifically, the relative relationship is estimated using a line segment connecting at least any two points in a region in which a surrounding vehicle is captured in the image. The thus obtained relative relationship may be used for control of vehicles in automatic driving, for example.

Next, in addition to the aforementioned line segment, information that can be acquired by a sensor and the like mounted on the host vehicle and information required for estimation and obtained from another object captured in the above image are obtained, and an absolute relationship between the surrounding vehicle and a road is estimated using the obtained information. The information that can be acquired by the sensor mounted in the host vehicle include, for example, the position of the host vehicle obtained by a global positioning system (GPS), or a speed obtained from a speed sensor. The information required for the estimation and obtained from another object captured in the image include, for example, lines that divide road lanes. In a more specific example, a lane on which a surrounding vehicle is traveling can be estimated by using the position of the host vehicle and the aforementioned relative relationship.

The thus obtained absolute relationship can be used for road pricing or estimation of a traffic flow.

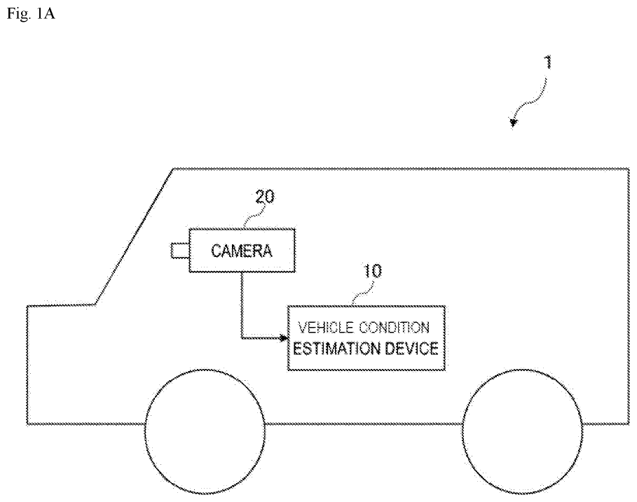

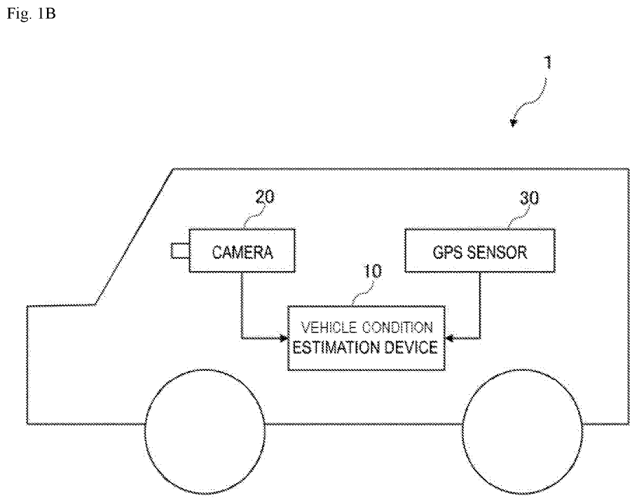

FIG. 1A is a diagram illustrating a schematic configuration of a vehicle condition estimation system including a vehicle condition estimation device according to the present embodiment. In FIG. 1A, a host vehicle 1 includes a vehicle condition estimation device 10 and a camera 20.

### First Embodiment

The vehicle condition estimation device 10 according to a first embodiment of the present disclosure estimates a relative relationship between the host vehicle 1 and a surrounding vehicle appearing in an image captured from any position of the host vehicle 1. The relative relationship mentioned herein is a position or a traveling direction of a surrounding vehicle with reference to the host vehicle 1.

The vehicle condition estimation device 10 is a device that estimates a condition of an estimation target based on an image captured by the camera 20. The condition in the first embodiment is the aforementioned relative relationship between the surrounding vehicle and the host vehicle 1. Note that the surrounding vehicle is an example of an imaged object, and the imaged object may be another object that is present on a road such as a manhole or a road marking. The relative relationship is a position or a traveling direction of the surrounding vehicle with reference to the host vehicle. The vehicle condition estimation device 10 estimates a condition of the surrounding vehicle with reference to the position of the host vehicle 1 at a timing at which the surrounding vehicle is imaged, using image data obtained by imaging a range including a road region in a traveling direction in which the host vehicle 1 is traveling. An exemplary functional configuration of the vehicle condition estimation device 10 will be described below.

The camera 20 is an imaging device using a solid-state imaging device such as a complementary metal oxide semiconductor (CMOS) sensor, for example. An installation location, an elevation angle, and an azimuth angle of the camera 20 are set so as to include, in the imaging range, at least a road region in the traveling direction in which the host vehicle 1 is traveling. Then, the camera 20 outputs, to the vehicle condition estimation device 10, image data obtained by imaging the range including the road region in the traveling direction of the host vehicle 1.

The camera 20 may be provided mainly for estimation of a condition of the surrounding vehicle performed by the vehicle condition estimation device 10, or a camera mounted in the host vehicle 1 for a purpose other than the estimation of the condition of the surrounding vehicle may be used. For example, a camera mounted in the host vehicle 1 for a purpose other than the estimation of the condition of the surrounding vehicle, such as a drive recorder or a stereo camera for the purpose of measuring inter-vehicle distances may be used. Further, in a case in which the host vehicle 1 is a motorcycle or a bicycle, for example, a camera provided on a helmet of a rider or a handlebar may be used as the camera 20. Furthermore, a camera provided in a mobile terminal such as a smartphone owned by a passenger of the host vehicle 1, for example, may be used as the camera 20. Any camera capable of imaging the surrounding environment of the host vehicle 1 may be used as the camera 20 regardless of how the camera is installed. The camera provided in the host vehicle 1 may image in any direction including a front direction, a rear direction, or a side direction. Further, the camera 20 may be an infrared camera that detects infrared rays. Further, the image data output by the camera 20 may be video data or may be stationary image data imaged at constant time intervals. Further, an image captured by a camera installed at a roadside may be used instead of the camera 20 mounted in the host vehicle 1. In this case, the vehicle condition estimation device 10 estimates a relative positional relationship between the position of the camera installed at a roadside and the surrounding vehicle.

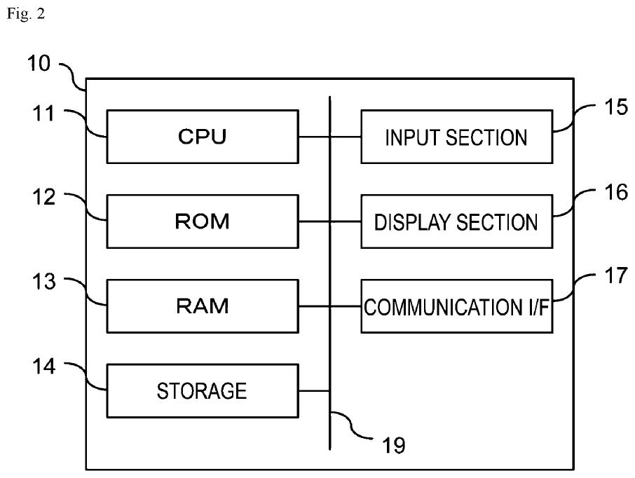

FIG. 2 is a block diagram illustrating a hardware configuration of the vehicle condition estimation device 10.

As illustrated in FIG. 2, the vehicle condition estimation device 10 includes a central processing unit (CPU) 11, a read only memory (ROM) 12, a random access memory (RAM) 13, a storage 14, an input section 15, a display section 16, and a communication interface (I/F) 17. The components are communicatively interconnected through a bus 19.

The CPU 11 is a central processing unit that executes various programs and controls each section. In other words, the CPU 11 reads a program from the ROM 12 or the storage 14 and executes the program using the RAM 13 as a work area. The CPU 11 controls each of the above-described components and various arithmetic processing operations in accordance with programs stored in the ROM 12 or the storage 14. In the present embodiment, the ROM 12 or the storage 14 stores a vehicle condition estimation program for estimating conditions of surrounding vehicles.

The ROM 12 stores various programs and various kinds of data. The RAM 13 serves as a work area and temporarily stores programs or data. The storage 14 is composed of a storage device such as a hard disk drive (HDD) or a solid state drive (SSD) and stores various programs including an operating system and various kinds of data.

The input section 15 includes a pointing device such as a mouse and a keyboard and is used for performing various inputs.

The display section 16 is, for example, a liquid crystal display and displays various kinds of information. A touch panel system may be used in the display section 16 so that the display section 16 functions as the input section 15.

The communication interface 17 is an interface for communicating with another equipment such as an external device, and for example, a wireless communication standard such as 4G, 5G, and Wi-Fi (trade name) is used.

Next, a functional configuration of the vehicle condition estimation device 10 will be described.

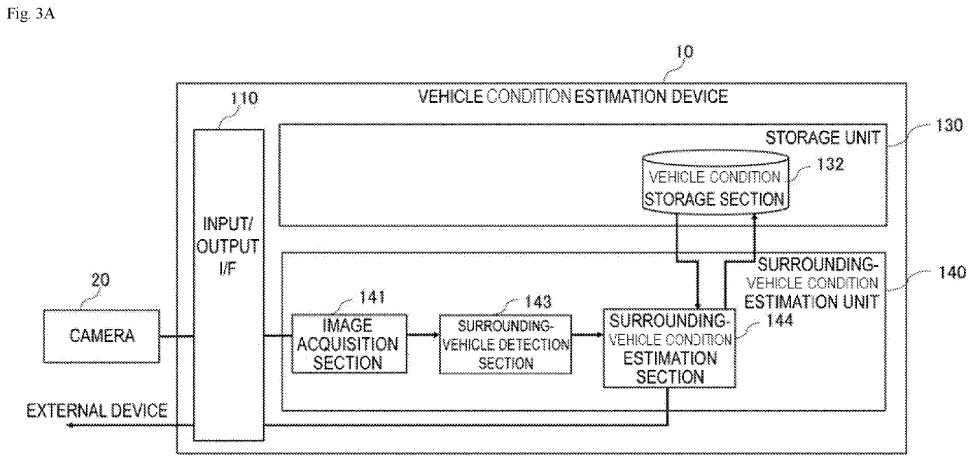

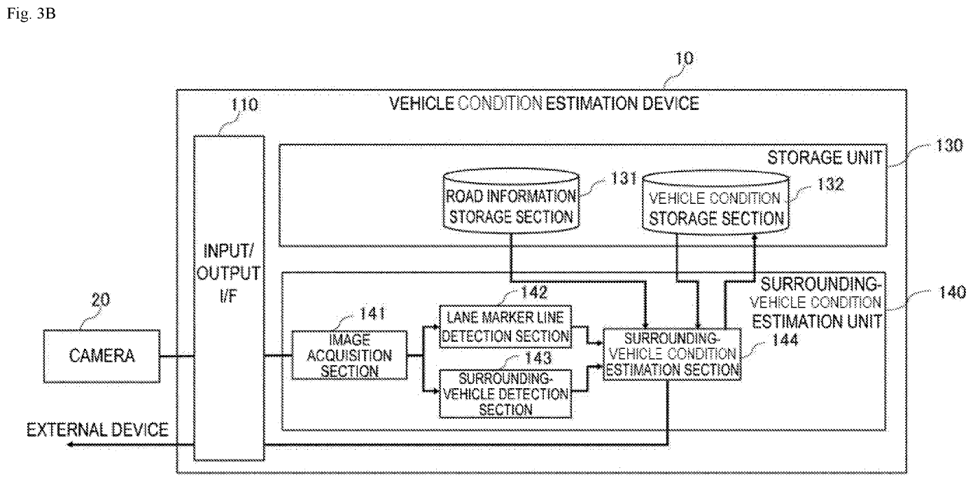

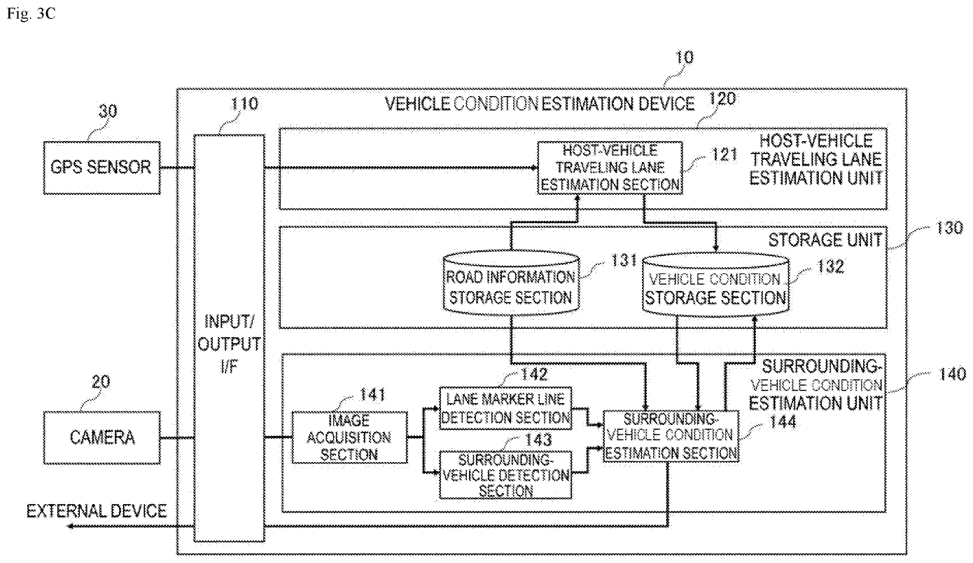

FIG. 3A is a block diagram illustrating an example of a functional configuration of the vehicle condition estimation device 10.

As illustrated in FIG. 3A, the vehicle condition estimation device 10 includes, as functional constituents, an input/output interface (I/F) 110, a storage unit 130, and a surrounding-vehicle condition estimation unit 140. Each functional constituent is realized by the CPU 11 reading the vehicle condition estimation program stored in the ROM 12 or the storage 14 and developing and executing the vehicle condition estimation program in the RAM 13.

The input/output I/F 110 receives an image captured by the camera 20 and supplies received data to the surrounding-vehicle condition estimation unit 140. In addition, the input/output I/F 110 may output, to an external device (not illustrated), data representing the estimation result of surrounding vehicle output from the surrounding-vehicle condition estimation unit 140. The external device can be a display or a speaker mounted in the host vehicle 1, for example.

The storage unit 130 is provided in the ROM 12 or the storage 14, for example. The storage unit 130 includes a vehicle condition storage section 132.

The vehicle condition storage section 132 stores a relative relationship with a surrounding vehicle with reference to the host vehicle 1 along with a clock time at which the relationship is estimated, the relative relationship being estimated by the surrounding-vehicle condition estimation section 144.

The surrounding-vehicle condition estimation unit 140 estimates a relative relationship between the host vehicle 1 and a surrounding vehicle. The surrounding-vehicle condition estimation unit 140 includes an image acquisition section 141, a surrounding-vehicle detection section 143, and a surrounding-vehicle condition estimation section 144.

The image acquisition section 141 successively takes in image data output from the camera 20 via the input/output I/F 110. The image acquisition section 141 outputs, to the surrounding-vehicle detection section 143, the taken image data in association with information representing an imaging timing or a reception timing of the image data. Note that the image acquisition section 141 may cut out stationary image data at predetermined frame time intervals and then output the cutout stationary image data to the lane marker line detection section 142 and the surrounding-vehicle detection section 143 as additional processing in a case in which the aforementioned image data is video data. The image acquisition section 141 may perform noise removal and calibration processing for correcting individual differences of performance or an inclination at the time of installation of the camera 20 on the aforementioned stationary image data as additional processing. An image acquisition section (not illustrated) may be provided outside the surrounding-vehicle condition estimation unit 140 instead of the image acquisition section 141, and image data may be output from the image acquisition section provided outside to the surrounding-vehicle detection section 143.

The surrounding-vehicle detection section 143 detects a region in which a surrounding vehicle is imaged in image data from the image data received from the image acquisition section 141. The region may have a rectangular shape. In a case in which the region has a rectangular shape, sets of coordinates of the rectangle in the image data are calculated. The surrounding-vehicle detection section 143 sends information regarding sets of coordinates of a circumscribed rectangle that circumscribes the detected region on image data of the surrounding vehicle to the surrounding-vehicle condition estimation section 144. The surrounding-vehicle detection section 143 may send only coordinates of two points constituting edges of the circumscribed rectangle to the surrounding-vehicle condition estimation section 144. The coordinates of the two points may be coordinates of two apexes that correspond to opposing corners of the circumscribed rectangle, for example. The circumscribed rectangle is a smallest rectangle including the entire region in which a surrounding vehicle is imaged and may be a minimum rectangle substantially including a region in which the surrounding vehicle is imaged. “Substantially including” means that the region in which the surrounding vehicle is imaged may protrude slightly from the rectangle.

Note that although an example in which a circumscribed rectangle is used is illustrated in the present embodiment, the surrounding-vehicle detection section 143 may use information regarding the shape of a surrounding vehicle. The shape of a surrounding vehicle may be a circumscribed hexagon regarding the shape of the surrounding vehicle, for example. The surrounding-vehicle detection section 143 may calculate not only the coordinates of apexes of the circumscribed rectangle or the circumscribed hexagon but also coordinates of pixels estimated as a “vehicle” in an image by a semantic segmentation method. In addition, the surrounding-vehicle detection section 143 may calculate coordinates of two points included in ground contact surfaces of tires of the surrounding vehicle. Although the surrounding-vehicle detection section 143 preferably calculates coordinates of one point for each tire, the surrounding-vehicle detection section 143 may calculate coordinates of two points from one tire. In addition, the surrounding-vehicle detection section 143 may detect tires, then detect a vehicle body, and categorize a plurality of detected tires as tires constituting the same vehicle using a region of the detected vehicle body.

The surrounding-vehicle condition estimation section 144 performs processing of estimating a relative relationship between the host vehicle 1 and the surrounding vehicle. Specifically, the surrounding-vehicle condition estimation section 144 performs processing of estimating a condition of the surrounding vehicle using coordinates of the circumscribed rectangle that circumscribes the surrounding vehicle detected by the surrounding-vehicle detection section 143. The estimation processing will be described below in detail.

The surrounding-vehicle condition estimation section 144 may estimate the condition of the surrounding vehicle to be estimated, using information regarding the surrounding vehicle to be estimated and the camera 20 that is not affected by a change in relationship with the camera 20 as in a third embodiment described below. The aforementioned information regarding the camera 20 may be any one of the position of the camera 20 and the road in which the camera 20 is provided.

Next, actions of the vehicle condition estimation device 10 will be described.

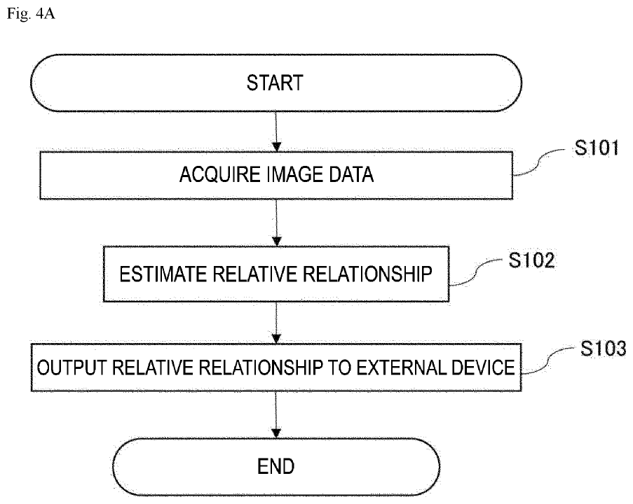

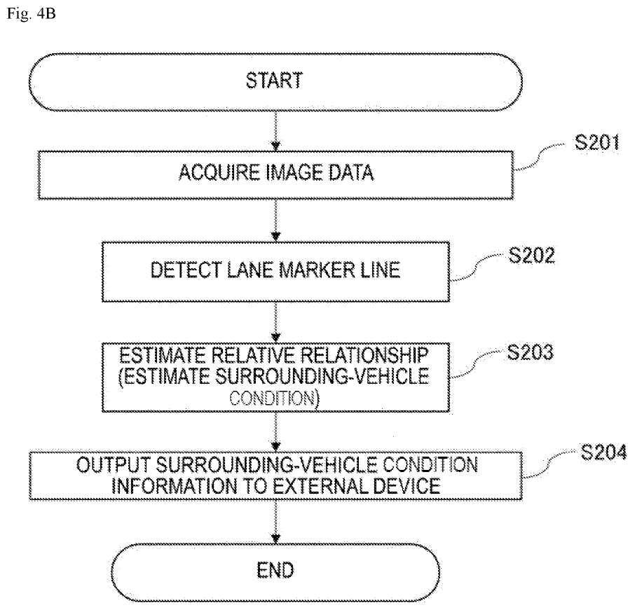

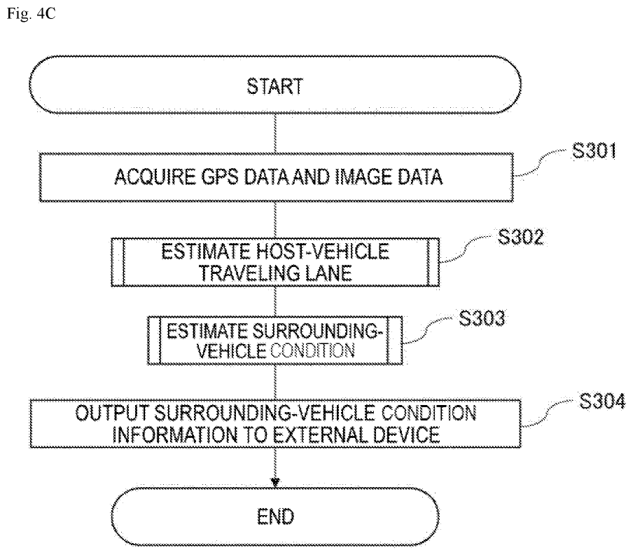

FIG. 4A is a flowchart illustrating a flow of vehicle condition estimation processing performed by the vehicle condition estimation device 10. The vehicle condition estimation processing is performed by the CPU 11 reading the vehicle condition estimation program from the ROM 12 or the storage 14 and developing and executing the program in the RAM 13.

First, the CPU 11 acquires image data captured by the camera 20 (Step S101).

Following Step S101, the CPU 11 estimates a relative relationship between the host vehicle and the surrounding vehicle using the image data acquired from the camera 20 (Step S102). The processing in Step S102 will be described below.

Following Step S102, the CPU 11 outputs the relative relationship between the host vehicle and the surrounding vehicle to an external device (Step S103).

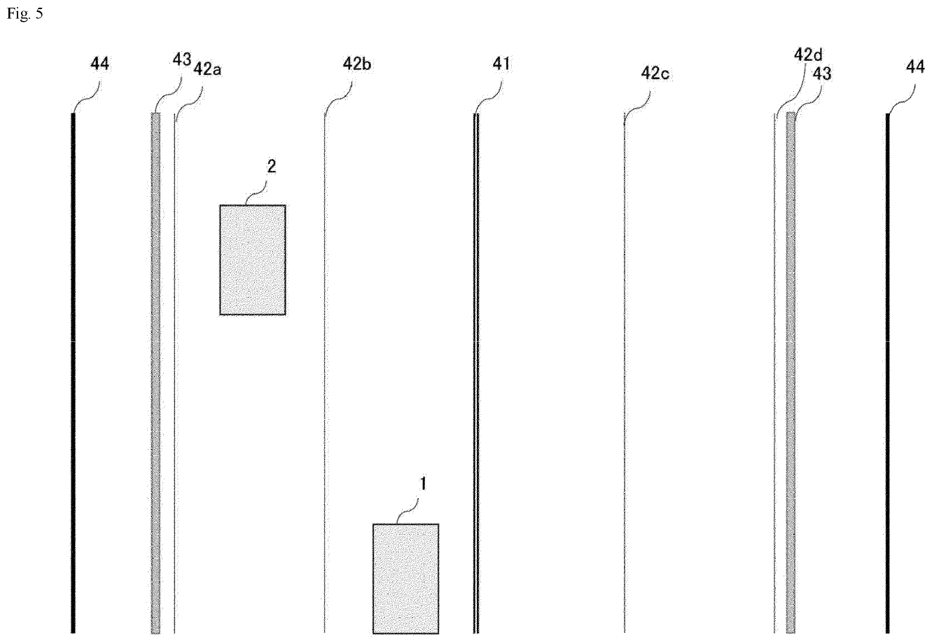

FIG. 5 is a diagram illustrating an example in the present embodiment. In FIG. 5, it is assumed that the host vehicle 1 is traveling on the second lane from the left and the surrounding vehicle 2 is traveling on the first lane from the left on a road including a total of four inbound and outbound lanes with sidewalks and roadside strips, namely two lanes on one side of left-side traffic. The sign 41 represents a median strip, the signs 42a to 42d represent lane marker lines for dividing lanes, the sign 43 represents a curbstone, and the sign 44 represents the boundary between the sidewalk and buildings. The median strip 41 is an example of the lane marker lines. Thus, parts between the median strip 41 and the lane marker lines 42b and 42c, a part between the lane marker lines 42a and 42b, and a part between the lane marker lines 42c and 42d are lanes, parts between the lane marker lines 42a and 42d and the curbstones 43 are roadside strips, and parts between the curbstones 43 and the boundaries 44 are sidewalks.

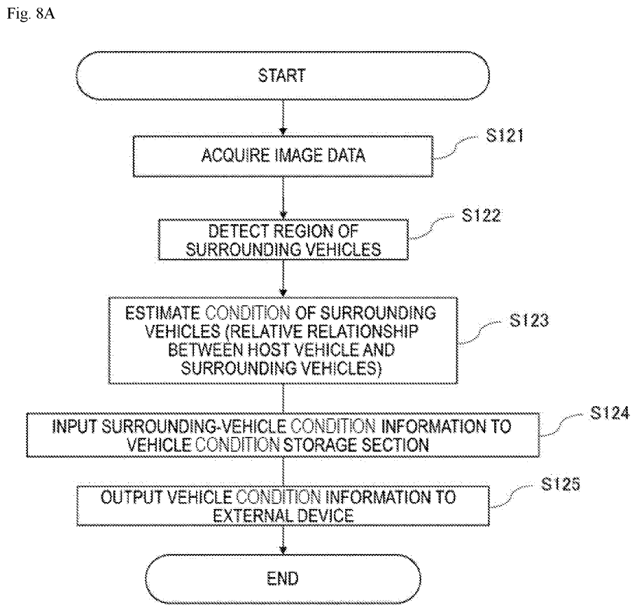

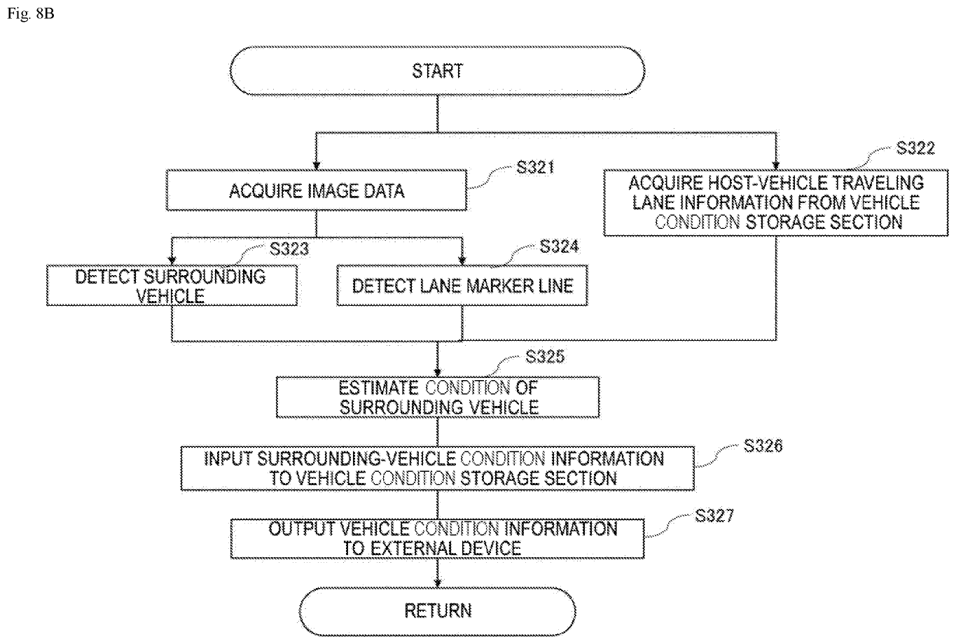

FIG. 8A is a flowchart illustrating details of processing illustrated in Step S102 in FIG. 4A.

The CPU 11 acquires image data from the camera 20 (Step S121).

The CPU 11 detects a region in which the surrounding vehicle that is present in the image data has been imaged, using the image data acquired from the camera 20 (Step S122) and clarifies the region of the image data in which the surrounding vehicle appearing in the image data is imaged. This region may have a rectangle shape including the surrounding vehicle as described above.

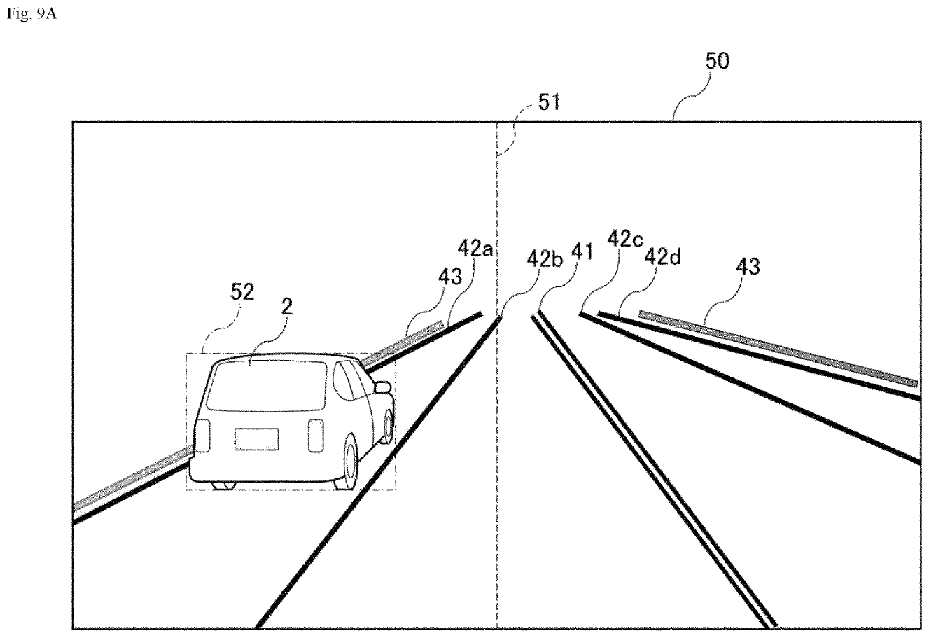

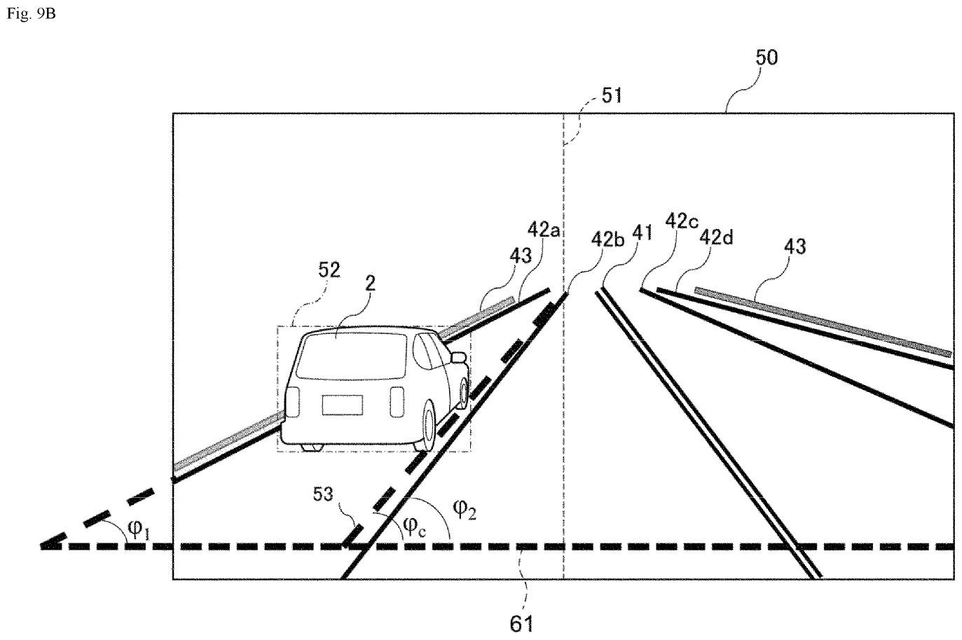

FIG. 9A is a diagram illustrating an example in which a rectangle 52 including the region where the surrounding vehicle is imaged is detected from certain image data.

For the detection of the region in which the surrounding vehicle is imaged in the image data, an algorithm of detecting an object captured in an arbitrary image may be used, or a neural network such as a convolutional neural network (CNN) may be used. Specifically, the detection may be performed using You Look Only Once (YOLO) (see https://arxiv.org/abs/1612.08242 and the like). Note that although FIG. 9A illustrates, as an example, a case in which the single surrounding vehicle 2 is present in the image data, in a case in which a plurality of surrounding vehicles 2 are imaged, the CPU 11 detects regions in which the surrounding vehicles 2 are imaged for each surrounding vehicle 2.

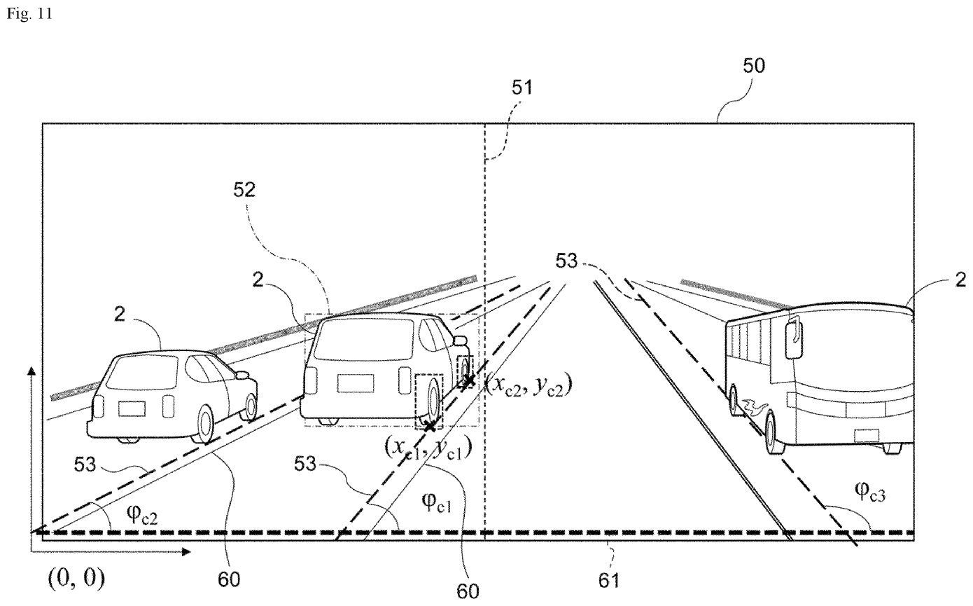

The CPU 11 detects a pair of a front wheel and a rear wheel that is present on one side of the vehicle body of the surrounding vehicle from the image data when a traveling direction of the surrounding vehicle is estimated. Moreover, the CPU 11 obtains coordinates of lowermost portions of the detected front wheel and rear wheel in the image. Although the coordinates of the lowermost portions are coordinates for acquiring ground contact locations of the front wheel and the rear wheel, the coordinates obtained by the CPU 11 may be any two points in the region in which the surrounding vehicle is imaged. The reason why the CPU 11 preferably obtains the coordinates of the lowermost portions of the front wheel and the rear wheel will be described. Tires of general cars are in a ground contact condition with respect to roads, and ground contact locations of front wheels and ground contact locations of rear wheels are present substantially on straight lines. Also, the reason is because the straight lines are substantially parallel to the traveling direction of the cars. Also, the reason is because the traveling direction of the cars are substantially parallel with roads. The parallelism will be described using FIG. 11. A lane marker line 60 is present on a road although it is not used in the present embodiment. The parallelism is defined that a difference between an angle formed by a horizontal line 61 and the lane marker line 60, which will be described later, and an angle formed by the aforementioned straight line and the horizontal line 61 is less than a predetermined threshold value.

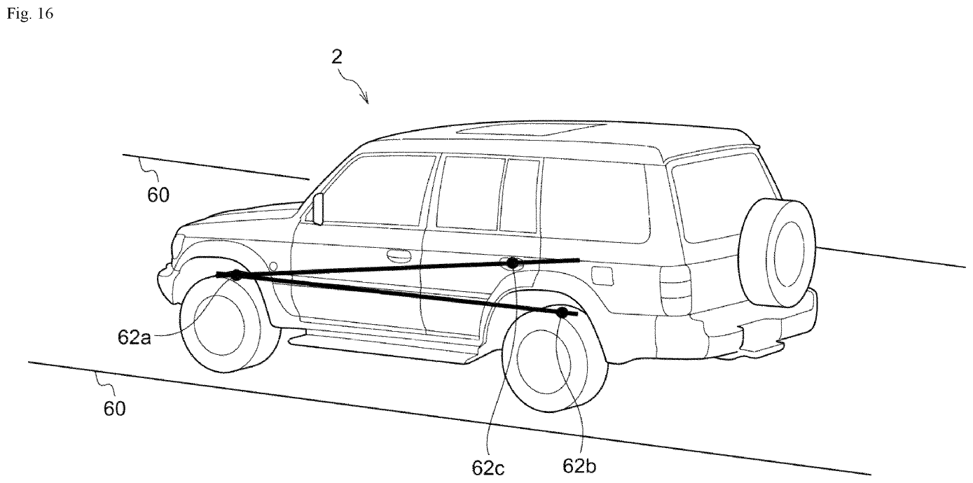

In a case in which two points other than the front wheel and the rear wheel are used, the condition to be satisfied by the two points is that a line connecting the two points is in a substantially parallel relationship with the road like on a side step. Moreover, the CPU 11 may select two points near a ground contact surface or select points that a line that divides the shape of the surrounding vehicle 2 into two parts on the left and right sides can be obtained, in accordance with the height of the camera 20 that has captured the image from the ground and the vehicle height of the surrounding vehicle 2. In this case, the CPU 11 is only required to obtain points that a line that divides a region of the surrounding vehicle 2 into two parts on the left and right sides can be obtained, as long as a difference between the height of the camera 20 from the ground and the vehicle height of the surrounding vehicle 2 is equal to or greater than a predetermined threshold value. Also, it is only necessary for the CPU 11 to obtain two points that are as close to the ground contact surface as possible if the difference is equal to or less than the predetermined threshold value. Here, a horizontal relationship with respect to the road will be described using FIG. 16. A line segment connecting a point 62a and a point 62b on the opposite side of the ground contact surface with reference to the center of the tires are in a horizontal relationship with the road, and a line segment connecting the point 62a and a point 62c near a door knob is not in a horizontal relationship with the road. In other words, the horizontal relationship means a line segment with a height in a real space that does not substantially change with reference to the lowermost surface of the vehicle.

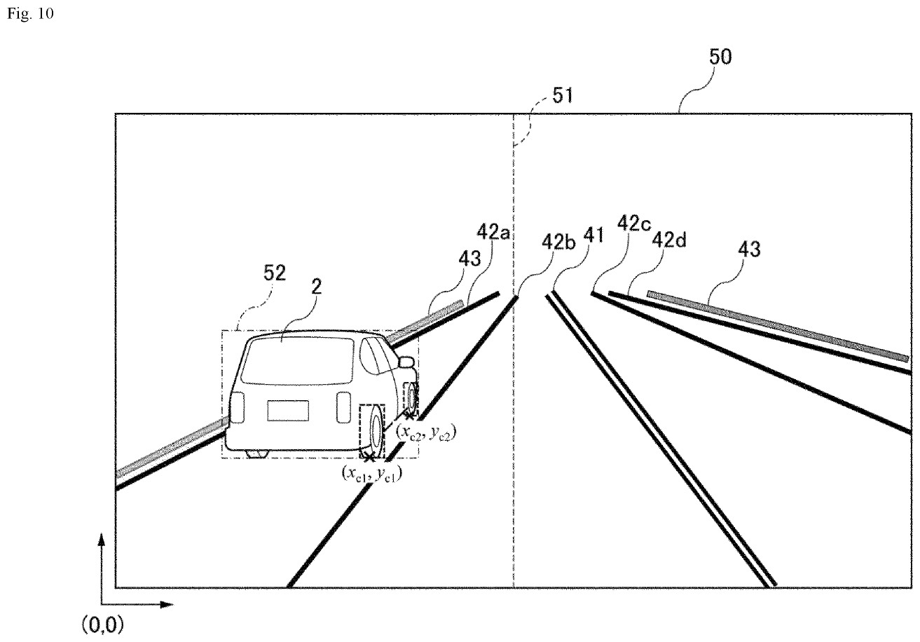

In the present embodiment, an origin of coordinates is defined as the left lower part of the image data. FIG. 10 is a diagram illustrating coordinates of lowermost portions of the front wheel and the rear wheel that are present on one side of the vehicle body of the surrounding vehicle 2. The CPU 11 obtains coordinates (x_{c1}, y_{c1}) of the lowermost portion of the rear wheel of the surrounding vehicle 2 and coordinates (x_{c2}, y_{c2}) of the lowermost portion of the front wheel of the surrounding vehicle 2 from the image data 50. Note that both of the front wheel and the rear wheel of the surrounding vehicle 2 may also be detected inside the circumscribed rectangle 52 of the surrounding vehicle 2 using an object detection algorithm such as YOLO.

Once the CPU 11 obtains the coordinates of the lowermost portions of the front wheel and the rear wheel that are present on one side of the vehicle body of the surrounding vehicle 2, the CPU 11 then obtains a line segment passing through the obtained coordinates and an angle formed by the line segment and the horizontal line 61 in the image data 50. The line segment obtained here is a line segment connecting at least two points in the region in which the surrounding vehicle is imaged, for example, a line segment connecting points constituting a region in which the two tires of the vehicle are in contact with the ground. The horizontal line will be described. The horizontal line is a virtual line segment that is not captured in the photograph and is a line segment having a fixed y coordinate when the image is regarded as an xy plane and passing through two points with any x coordinates. FIG. 11 illustrates an example of the horizontal line 61. Note that although it is assumed that the camera is installed with a horizontal relationship with the road, the image itself may be corrected to obtain a horizontal relationship with respect to the road in a case in which the camera is not in a horizontal relationship with the road.

FIG. 11 is a diagram illustrating an example of the image data 50. The angle φ_{c1} illustrated in FIG. 11 is an example of the angle formed by the line segment and the horizontal line 61 related to the surrounding vehicle 2 located on the left side with reference to the host vehicle 1. In other words, FIG. 11 is a diagram for explaining the angle formed by the line segment passing through the coordinates of the lowermost portions of the front wheel and the rear wheel that are present on one side of the vehicle body of the surrounding vehicle 2 and the horizontal line 61. The CPU 11 calculates the angle φ_{c} formed by a line segment 53 passing through the coordinates (x_{c1}, y_{c1}) and (x_{c2}, y_{c2}) and the horizontal line 61 by the following equation.

φ_{c}=arctan{(y_{c2}−y_{c1})/(x_{c2}−x_{c1})}

The CPU 11 can estimate whether the surrounding vehicle is located on the left side or the right side with reference to the host vehicle 1 and how far the surrounding vehicle is from the host vehicle 1, based on the obtained angle φ_{c}. In other words, the CPU 11 can estimate that the surrounding vehicle 2 is located on the left side of the host vehicle 1 when φ_{c} is equal to or less than a first predetermined threshold value, and the CPU 11 can estimate that the surrounding vehicle 2 is located on the right side of the host vehicle 1 when φ_{c} is equal to or greater than the first predetermined threshold value. The CPU 11 may estimate the distance between the host vehicle 1 and the surrounding vehicle 2 based on the difference between the first threshold value and φ_{c} is. Note that the distance mentioned herein is the distance in the lateral direction with reference to the host vehicle. The CPU 11 may estimate that the distance between the host vehicle 1 and the surrounding vehicle 2 becomes longer as the difference between the first threshold value and φ_{c} becomes smaller in a case in which φ_{c} is equal to or less than the first threshold value, that is, in a case in which the surrounding vehicle 2 is located on the left side. In a case in which φ_{c} is equal to or greater than the first threshold value, that is, in a case in which the surrounding vehicle 2 is located on the right side, the CPU 11 may estimate that the distance between the host vehicle and the surrounding vehicle becomes longer as the difference between the first threshold value and φ_{c} becomes larger. A specific example will be described. If φ_{c} is an angle that is less than 90 degrees, such as 20 degrees or 47 degrees, for example, the CPU 11 may estimate that the surrounding vehicle 2 is located on the left side of the host vehicle 1. Also, in a case in which a plurality of surrounding vehicles 2 are imaged as in FIG. 11, the CPU 11 may estimate that the surrounding vehicle 2 that has acquired φ_{c1} of 47 degrees is located closer to the host vehicle 1, of the surrounding vehicle 2 that has acquired φ_{c2} of 20 degrees and the surrounding vehicle that has acquired φ_{c1} of 47 degrees. If φ_{c3} is 165 degrees, the CPU 11 may estimate that the surrounding vehicle 2 is located on the right side of the host vehicle 1.

Moreover, the CPU 11 may estimate how far the lane on which the surrounding vehicle 2 is traveling is from the lane on which the host vehicle 1 is traveling, in accordance with the distance between the estimated position of the surrounding vehicle 2 and the host vehicle 1. As will be described in a second embodiment below, in a case in which a center line of a road is known or given, the CPU 11 may estimate, based on the size of φ_{c}, whether the surrounding vehicle 2 is traveling in the same direction as the host vehicle 1 or traveling in the opposite direction. Note that it is obvious that the center line of the road is not required to be used in the first embodiment.

In this manner, the vehicle condition estimation device 10 estimates a relative relationship with the surrounding vehicle 2 using an image captured by the host vehicle 1 in the first embodiment. Because only the image is used, and a large amount of calculation is not needed, the processing may be executed only by a digital signal processor (DSP) mounted in the host vehicle 1. In the case in which the processing is executed by the DSP mounted in the host vehicle 1, communication for executing the processing is not needed. Thus, the amount of communication of the host vehicle 1 can be reduced. Also, in a case in which the processing of estimating the relative relationship with the surrounding vehicle 2 is consolidated on a server, or in a case in which the processing is performed by dispersed edges, minimum data required is only the angle φ_{c}, and thus similarly, the amount of communication can be reduced. Moreover, because information regarding lane marker lines are not used in the first embodiment, the vehicle condition estimation device 10 can estimate the relative relationship between the host vehicle 1 and the surrounding vehicle 2 in a road with no lane marker lines.

Note that the vehicle condition estimation device 10 may estimate the relative relationship between the camera and the surrounding vehicle using an image captured by a camera for imaging the road, such as a camera installed at a roadside instead of the host vehicle 1, as described above.

### Second Embodiment

In a second embodiment of the present disclosure, a lane on which the surrounding vehicle is traveling with reference to the lane on which the host vehicle is traveling, that is, a relative lane relationship between the host vehicle and the surrounding vehicle is estimated in addition to the relative positional relationship between the host vehicle and the surrounding vehicle estimated in the first embodiment. In the second embodiment, lane marker lines are detected from the image in addition to the first embodiment. In other words, the lane marker lines that are boundaries of lanes are detected from an image captured by a camera mounted in the host vehicle, and by using the image along with the angle φ_{c} obtained in the first embodiment, the relative lane relationship between the host vehicle and the surrounding vehicle is estimated.

FIG. 3B is a block diagram illustrating an example of a functional configuration of a vehicle condition estimation device 10 according to the second embodiment. Points that are different from those in the first embodiment will be mainly described with reference to FIG. 3B.

The vehicle condition estimation device 10 according to the second embodiment is different from that in the first embodiment in that a road information storage section 131 is added to the storage unit 130 and a lane marker line detection section 142 is added to the surrounding-vehicle condition estimation unit 140.

The lane marker line detection section 142 detects ranges corresponding to lane marker lines from image data received from the image acquisition section 141. Information regarding the ranges corresponding to the detected lane marker lines may be stored in the road information storage section 131. The lane marker line detection section 142 sends, to the surrounding-vehicle condition estimation section 144, the information regarding the ranges corresponding to the lane marker lines in the image data. The information regarding the ranges corresponding to the lane marker lines may be coordinates of four ends or two ends of each lane marker line, for example. In a case in which each lane marker line is a dotted line, the lane marker line detection section 142 obtains a line segment from coordinates of two ends related to a dotted line of each lane marker line for an image space with the left lower part of the image data defined as (0, 0). In a case in which the line segments obtained are extended, and the extended lines have similar positional relationships and angles, the lane marker line detection section 142 uniquely handles the line segments as lane marker lines representing the same lane. Then, the lane marker line detection section 142 may use coordinates with the largest Y coordinate value and coordinates with the smallest Y coordinate value among the collected coordinates as the information regarding the ranges corresponding to the lane marker lines. Also, the lane marker line detection section 142 may connect a plurality of dotted lines to obtain a single lane marker line.

The lane marker line detection section 142 may perform processing of correcting, through scale conversion processing or the like, a region erroneously detected as a lane marker line, a region erroneously detected as a non-lane marker line due to contamination or wear of the lane marker line. The lane marker line detection section 142 may determine whether erroneous detection as a non-lane marker line has been made based on a result of machine learning, for example. The lane marker line detection section 142 may perform edge extraction processing using an edge extraction filter. The lane marker line detection section 142 may perform straight line detection processing based on Hough transform.

The lane marker line detection section 142 may extract only lane marker lines (such as a road center line, lane boundary lines, and roadway outer lines, for example) representing an extending direction of the lanes based on differences in shapes and colors. Then, the lane marker line detection section 142 may perform processing of excluding lane marker lines (for example, approaching of obstacles on the road, and a lane marker line representing a buffer zone) other than the extracted lane marker lines and some of road signs (a maximum speed, traffic division for each traveling direction, and the like) from extraction targets. In some cases, lane marker lines are scratched and erased, or no lane marker lines are drawn on the roads from the beginning. Moreover, this is because it is possible to estimate the lane on which the vehicle to be estimated is traveling, by using only the absolute position of the host vehicle such as a latitude and a longitude and a previously estimated relative position between the host vehicle and the vehicle to be estimated depending on the number of lanes. Also, because the number of lanes of the road on which the vehicle to be estimated is traveling is the number of lanes of the road on which the host vehicle 1 is traveling, the number of lanes of the road on which the vehicle to be estimated is traveling may not be acquired as additional information.

FIG. 4B is a flowchart illustrating a flow of vehicle condition estimation processing performed by the vehicle condition estimation device 10. The vehicle condition estimation processing is performed by the CPU 11 reading the vehicle condition estimation program from the ROM 12 or the storage 14 and developing and executing the program in the RAM 13.

The second embodiment is different from the first embodiment in that the lane marker lines detected in the estimation of the relative relationship is used in addition to the detection of the lane marker lines.

First, the CPU 11 acquires image data captured by the camera 20 (Step S201).

Following Step S201, the CPU 11 detects lane marker lines using the image data acquired from the camera 20 (Step S202). The CPU 11 detects regions in which the lane marker lines have been imaged in the image data acquired from the camera 20. For the detection of the lane marker lines, a white line recognition system (see the 69th National Convention of IPSJ, “A New Lane Recognition Algorithm for Automotive Camera Images”, etc.) may be used, for example, or the aforementioned YOLO, machine learning, or the like may be used.

Next, estimation of a relative relationship (surrounding-vehicle condition estimation) will be described. As in the first embodiment, the CPU 11 acquires an angle φ_{c} formed by a line segment connecting coordinates of lowermost portions of the front wheel and the rear wheel that are located on one side of the vehicle body of the surrounding vehicle and the horizontal line 61. Moreover, the CPU 11 records which of the left side and the right side a detected lane marker line is present with reference to the center line. In a case in which the CPU 11 detects a plurality of lane marker lines on the left side and/or the right side, the CPU 11 may calculate the number of the lane marker line from the center line for each lane marker line with the center line as a reference.

If regions corresponding to the lane marker lines are detected, the CPU 11 also obtains angles formed by the horizontal line 61 and the regions corresponding to the lane marker lines in the image data 50 with respect to the lane marker lines 42a to 42d in FIG. 9A. Here, description will be given on the assumption that an angle formed by the horizontal line 61 in the image data 50 is obtained with respect to the lane marker lines 42a and 42b that define the lane in which the surrounding vehicle 2 is traveling.

First, the CPU 11 obtains coordinates of any two points for each of the lane marker lines 42a and 42b. The coordinates of the two points of the lane marker line 42a are (x₁₁, y₁₁) and (x₁₂, y₁₂), and the coordinates of the two points of the lane marker line 42b are (x₂₁, y₂₁) and (x₂₂, y₂₂). Then, the CPU 11 calculates angles φ₁ and φ₂ of the line segments passing through arbitrary two points of the lane marker lines 42a and 42b by the following equations.

φ₁=arctan{(y₁₂−y₁₁)/(x₁₂−x₁₁)}

φ₂=arctan{(y₂₂−y₂₁)/(x₂₂−x₂₁)}

Here, processing of estimating a relative relationship of the lane through which the surrounding vehicle 2 is traveling with reference to the lane on which the host vehicle 1 is traveling will be described using FIG. 9B. The CPU 11 estimates the relative relationship by using the angle (pc between the line segment 53 connecting the coordinates of the lowermost portions of the front wheel and the rear wheel that are located on one side of the vehicle body of the surrounding vehicle and the horizontal line 61 and the angles φ₁ and φ₂ formed by the horizontal line 61 and the regions corresponding to the lane marker lines 42a and 42b. In the example of FIG. 9B, a relationship of φ₁<φ_{c}≤φ₂ is satisfied. Accordingly, the CPU 11 can thus estimate that the surrounding vehicle 2 is traveling through a lane sandwiched between the lane marker line 42a and the lane marker line 42b. The lane marker line 42b is the first lane marker line from the left side with reference to the center line 51. The CPU 11 can thus estimate that the surrounding vehicle 2 is traveling on the first lane on the left side with reference to the lane in which the host vehicle is traveling.

Although only the angle φ₁ formed by the lane marker line 42a and the horizontal line 61 and the angle φ₂ formed by the lane marker line 42b and the horizontal line 61 in FIG. 9B are used in the example described above, the present disclosure is not limited to such an example. It is obvious that, for all the lane marker lines detected by the lane marker line detection section 142, the CPU 11 may estimate the relative relationship of the lane on which the surrounding vehicle is traveling with reference to the lane on which the host vehicle is traveling, by calculating the angle formed by the horizontal line 61 and comparing the calculated angles with the angle φ_{c}. Also, it is obvious that, for all the lane marker lines detected by the lane marker line detection section 142, the CPU 11 may estimate the relative relationship of the lane on which the surrounding vehicle is traveling with reference to the lane on which the host vehicle is traveling, by calculating the angle formed by the horizontal line 61 and determining the angle φ_{c} using, as a threshold value, the angles formed by the lane marker lines and the horizontal line. In other words, in a case in which angles formed by the lane marker lines 41, 42c, and 42d and the horizontal line 61 are defined as φ₃, φ₄, and φ₅, the CPU 11 estimates that the surrounding vehicle is traveling on the first lane on the left side with reference to the lane one which the host vehicle is traveling if φ₁≤φ_{c}≤φ₂. In a case in which ground contact surfaces of the two points of the tires cannot be detected, the CPU 11 may estimate that the surrounding vehicle 2 is traveling through the same lane as that of the host vehicle 1. Also, the CPU 11 may estimate that the surrounding vehicle 2 is traveling through the same lane as that of the host vehicle 1 even in a case in which the surrounding vehicle 2 is detected near the center line 51 in the image 50. The CPU 11 can estimate that the surrounding vehicle 2 is traveling on the first lane on the right side with reference to the lane on which the host vehicle 1 is traveling if φ₃≤φ_{c}≤φ₄.

Furthermore, in a case in which the surrounding-vehicle condition estimation unit 140 has a function that can detect that the lane marker line 41 is a center line in the roadway, the CPU 11 may estimate that the surrounding vehicle 2 is traveling in the opposite direction of the host vehicle 1 if φ₃≤φ_{c}.

Note that although the CPU 11 may estimate the traveling lane of the surrounding vehicle 2 based on the angles of the line segment 53 and the lane marker lines from the horizontal line, the CPU 11 may estimate the traveling lane of the surrounding vehicle 2 based on the inclination of the line segment 53 and the lane marker lines. In other words, the CPU 11 may estimate that the surrounding vehicle 2 is located between the lane marker lines 42a and 42b if the inclination of the line segment 53 (y_{c2}−y_{c1})/(x_{c2}−x_{c1}) is between the inclination of the lane marker line 42a(y₁₂−y₁₁)/(x₁₂−x₁₁) and the inclination of the lane marker line 42b (y₂₂−y₂₁)/(x₂₂−x₂₁).

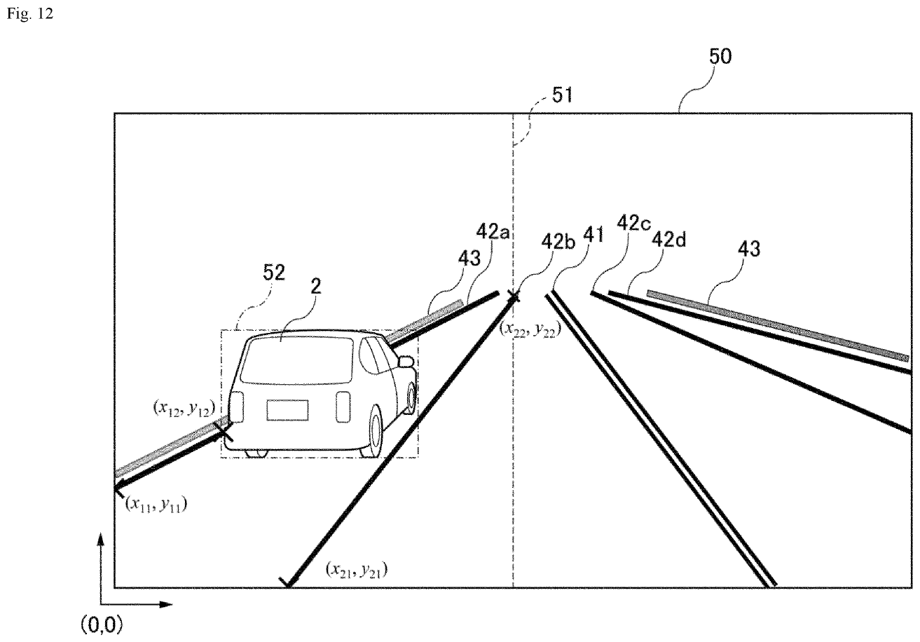

The CPU 11 may estimate how much margins from the lane marker lines the surrounding vehicle 2 is traveling. FIG. 12 is a diagram illustrating an example of the image data 50. The CPU 11 obtains, from the image data 50, a difference or a ratio of the distance between the coordinates (x_{c3}, y_{c3}) and (x₂₃, y₂₃) on the line segment 53 with respect to the distance between the coordinates (x₁₁, y₁₂) and (x₂₃, y₂₃) on left and right lane marker lines of the lane on which the surrounding vehicle 2 is traveling. The CPU 11 can estimate how much margin from the lane marker lines the surrounding vehicle 2 is traveling, by obtaining the difference or the ratio. In the example illustrated in FIG. 12, the CPU 11 can estimate that the surrounding vehicle 2 is traveling near the sidewalk side from the difference or the ratio.

The CPU 11 may estimate the traveling direction in which the surrounding vehicle is traveling, as a condition of the surrounding vehicle. Specifically, the CPU 11 may estimate the traveling direction of the surrounding vehicle by recognizing a front side or a rear side of the surrounding vehicle in the image data.

The CPU 11 determines whether the surrounding vehicle 2 and the surrounding vehicle 3 include parts that are located on the back side of the vehicles, such as rear lamps, break lamps, reflectors, and the like using an object recognition algorithm such as YOLO, for example. The CPU 11 estimates whether surrounding vehicle 2 and the surrounding vehicle 3 are facing the front side or the rear side depending on whether the parts located on the back side of the vehicles are included. The CPU 11 can estimate the traveling directions of the surrounding vehicles 2 and 3 by using the estimation result whether the surrounding vehicles 2 and 3 are facing the front side or the rear side in addition to the calculated line segments.

The CPU 11 may estimate a difference in traveling speeds of the surrounding vehicle and the host vehicle as a condition of the surrounding vehicle from two or more pieces of image data. Specifically, the CPU 11 can estimate a difference in traveling speeds with the surrounding vehicle as a condition of the surrounding vehicle from image data imaged at a plurality of clock times.

The CPU 11 obtains coordinates (x_{c1}, y_{c1})ₜ₋ₙ of the lowermost portion of the rear wheel of the surrounding vehicle 2 from image data 50a at a clock time t-n. Similarly, the CPU 11 obtains the coordinate (x_{c1}, y_{c1})ₜ of the lowermost portion of the rear wheel of the surrounding vehicle 2 from image data 50b at a clock time t. Then, the CPU 11 calculates a movement vector of the lowermost portion of the rear wheel of the surrounding vehicle 2 between the two pieces of image data. The CPU 11 further acquires the speed of the host vehicle 1 from on-board diagnostics (OBD), for example. The CPU 11 can calculate a difference in traveling speeds of the surrounding vehicle 2 and the host vehicle 1 from the speed of the host vehicle 1 and the movement vector of the lowermost portion of the rear wheel of the surrounding vehicle 2. Further, the CPU 11 can also estimate the traveling speed of the surrounding vehicle by obtaining a sum of the difference in traveling speeds and a traveling speed of the host vehicle in a case in which the traveling speed of the host vehicle is used as a parameter related to the host vehicle as in the third embodiment described below.

### Third Embodiment

The third embodiment of the present disclosure is different from the first embodiment and the second embodiment in that a parameter related to the host vehicle that is independent from the relationship between the host vehicle and the surrounding vehicle at a timing at which the image is captured, such as GPS coordinates, the traveling speed of the host vehicle, or the like is further used in addition to the image captured by the camera mounted in the host vehicle. The parameter related to the host vehicle is a traveling speed or positional information of the host vehicle, for example. An absolute relationship or condition, such as a traveling speed of the surrounding vehicle or a lane of the road on which the surrounding vehicle is traveling, is estimated by using the parameter related to the host vehicle in addition to the relative relationship estimated in the first embodiment or the second embodiment. In the following description, the absolute relationship or condition will be described as a condition of the surrounding vehicle.

First, points different from those in the first embodiment or the second embodiment in regard to a case in which the parameter related to the host vehicle is GPS coordinates will be mainly described.

FIG. 1B is a diagram illustrating a schematic configuration of a vehicle condition estimation system including a vehicle condition estimation device according to the third embodiment of the present disclosure. As illustrated in FIG. 1B, the vehicle condition estimation system according to the third embodiment of the present disclosure is different from those in the first embodiment and the second embodiment in that a vehicle condition estimation device 10, a camera 20, and a GPS sensor 30 are mounted in a host vehicle 1.

The vehicle condition estimation device 10 is a device that estimates a condition of the surrounding vehicle based on an image captured by the camera 20 and information output from the GPS sensor 30. For example, the vehicle condition estimation device 10 estimates a condition of a vehicle (surrounding vehicle) other than the host vehicle 1. Note that the surrounding vehicle is an example of an imaged object similarly to the first embodiment and the second embodiment and may be a structure such as a signboard, a road sign, or a feature that is adjacent to the road.

The vehicle condition estimation device 10 estimates at least any one of the lane on which the surrounding vehicle is traveling, a direction in which the surrounding vehicle is traveling, and a speed at which the surrounding vehicle is traveling as a condition of the surrounding vehicle, using image data obtained by imaging a range including a road region in the traveling direction in which the host vehicle 1 is traveling and the position at which the image data obtained by the GPS sensor 30 has been captured.

The GPS sensor 30 calculates the latitude and the longitude of the host vehicle 1 equipped with the GPS sensor 30 by receiving GPS signals transmitted from a plurality of GPS satellites and performing distance measurement calculations. The GPS sensor 30 outputs the calculated latitude and longitude as position data of the host vehicle 1 to the vehicle condition estimation device 10. Note that a ground (road) based positioning system (GBPS) may be used instead of the GPS sensor 30 in the present disclosure as long as functions equivalent to those of the GPS sensor 30 are exerted.

FIG. 3C is a block diagram illustrating an example of a functional configuration of the vehicle condition estimation device 10 according to the third embodiment. Points different from those in the first embodiment and the second embodiment will be mainly described using FIG. 3C.

The vehicle condition estimation device 10 according to the third embodiment is different from those in the first embodiment and the second embodiment in that a host-vehicle traveling lane estimation unit 120 is added.

An input/output I/F 110 receives an image captured by the camera 20 and data output from the GPS sensor 30 and supplies the received data to the host-vehicle traveling lane estimation unit 120 and the surrounding-vehicle condition estimation unit 140. The input/output I/F 110 may output, to an external device (not illustrated), data representing a result of estimating a condition of the surrounding vehicle output from the surrounding-vehicle condition estimation unit 140. The external device may be a display or a speaker mounted in the host vehicle 1, for example. In addition, the input/output I/F 110 may transmit the data to a server that is present outside the host vehicle or a vehicle other than the host vehicle using a communication unit (not illustrated).

The host-vehicle traveling lane estimation unit 120 estimates the lane on which the host vehicle 1 is traveling. The host-vehicle traveling lane estimation unit 120 includes an host-vehicle traveling lane estimation section 121. The host-vehicle traveling lane estimation section 121 acquires information regarding the latitude and the longitude of the host vehicle 1 transmitted from the GPS sensor 30. Also, the host-vehicle traveling lane estimation section 121 acquires information representing a configuration of a road corresponding to the latitude and the longitude from the road information storage section 131. Then, the host-vehicle traveling lane estimation section 121 estimates the lane on which the host vehicle 1 is traveling using the acquired information on the latitude and the longitude and the information representing the configuration of the corresponding road. Note that if the latitude and longitude information of the host vehicle 1 transmitted from the GPS sensor 30 has a large error and the lane on which the host vehicle 1 is traveling cannot be estimated with sufficient accuracy, the host-vehicle traveling lane estimation section 121 may correct the latitude and longitude information. The host-vehicle traveling lane estimation section 121 may correct the latitude and longitude information by, for example, map matching processing, traveling locus of the host vehicle 1, or analysis of image data acquired from the camera 20. Then, the host-vehicle traveling lane estimation section 121 may estimate the lane on which the host vehicle 1 is traveling after correcting the latitude and longitude information. Information regarding the lane through which the host vehicle is traveling may be acquired from the outside. For example, the information regarding the lane on which the host vehicle is traveling may be acquired from the outside, such as a vehicle other than the surrounding vehicle imaged by the camera mounted in the host vehicle or a camera located on a roadside.

The storage unit 130 is provided in the ROM 12 or the storage 14, for example. The storage unit 130 includes a road information storage section 131 and a vehicle condition storage section 132. The road information storage section 131 may store in advance information representing a configuration of the road corresponding to a position in association with position data represented by the latitude and the longitude, for example. The information representing the configuration of the road may include, for example, information representing the number of lanes in inbound and outbound directions, lane marker lines, and the number, types, and shapes of lane marker lines as latitude and longitude information or a latitude and longitude substitution system. Also, the information representing the road configuration may include information representing presence or absence of sidewalks, shoulders, roadside strips, and median strips, and widths thereof as latitude and longitude information or information representing by a latitude and longitude substitution system.

The vehicle condition storage section 132 may store the relative relationship between the host vehicle and the surrounding vehicle estimated in the first embodiment or the second embodiment along with a clock time at which the condition of the relationship has been estimated, for example.

The surrounding-vehicle condition estimation section 144 estimates the lane on which the surrounding vehicle is traveling, by using the relative relationship between the host vehicle and the surrounding vehicle obtained in the first embodiment or the second embodiment and the lane on which the host vehicle is traveling. The case will be described in which the relative relationship between the host vehicle and the surrounding vehicle is a lane on which the surrounding vehicle is traveling with reference to the lane on which the host vehicle is traveling. In a case in which the surrounding vehicle is estimated to be traveling on the first lane on the left side with reference to the lane on which the host vehicle is traveling, and the host vehicle is estimated to be traveling on the third lane (which is assumed to be the lane on the rightmost side), the surrounding-vehicle condition estimation section 144 can estimate that the surrounding vehicle is traveling on the first lane on the left from the third lane, and thus it is estimated that the surrounding vehicle is traveling through the second lane.

Next, an overview of the vehicle condition estimation processing according to the third embodiment will be described using FIG. 4C. The vehicle condition estimation processing is performed by the CPU 11 reading the vehicle condition estimation program from the ROM 12 or the storage 14 and developing and executing the program in the RAM 13.

First, the CPU 11 acquires GPS data acquired by the GPS sensor 30 and image data captured by the camera 20 (Step S301).

Following Step S301, the CPU 11 estimates a traveling lane of the host vehicle using the GPS data acquired from the GPS sensor 30 (Step S302). The host-vehicle traveling lane estimation processing in Step S302 will be described below.

Following Step S302, the CPU 11 estimates a condition of the surrounding vehicle, from the relative relationship between the host vehicle and the surrounding vehicle, using the image data acquired from the camera 20 (Step S303). The processing in S303 is similar to that in the first embodiment and the second embodiment, detailed description of the processing will thus be omitted.

The CPU 11 may use a result of estimating the traveling lane of the host vehicle as needed when the condition of the surrounding vehicle is estimated.

Following Step S303, the CPU 11 outputs, to an external device, surrounding-vehicle condition information that is information of a condition of the surrounding vehicle obtained by estimating the condition of the surrounding vehicle, from the relative relationship between the host vehicle and the surrounding vehicle (Step S304).

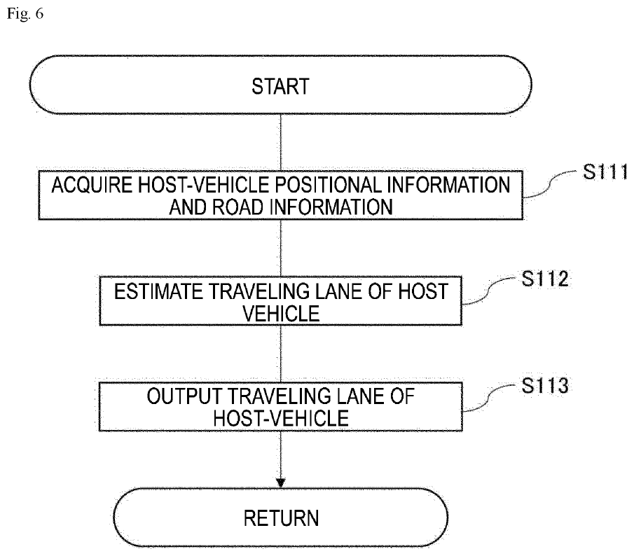

Next, details of the host-vehicle traveling lane estimation processing illustrated in Step S302 in FIG. 4C will be described using FIG. 6. The CPU 11 acquires host-vehicle positional information representing positional information of the host vehicle 1 and road information of the road on which the host vehicle 1 is traveling during the traveling of the host vehicle 1 (Step S111). The host-vehicle positional information is GPS data (N_{c}, E_{c}). (N_{c}, E_{c}) means a pair of the latitude and the longitude of the host vehicle 1. The CPU 11 acquires the road information from the road information storage section 131.

Following Step S111, the CPU 11 estimates the traveling lane of the host vehicle 1 based on the host-vehicle positional information and the road information (Step S112).

Following Step S112, the CPU 11 outputs information regarding the traveling lane of the host vehicle 1 to the vehicle condition storage section 132 (Step S113).

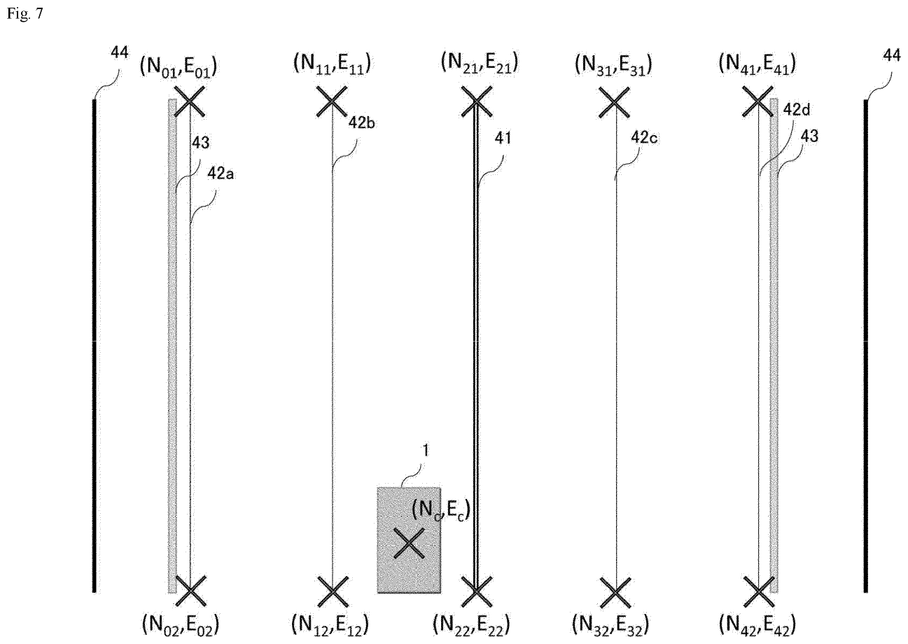

FIG. 7 is a diagram for explaining the host-vehicle traveling lane estimation processing. Specifically, the CPU 11 acquires information regarding the number of lanes of the road on which the host vehicle 1 is traveling from the road information storage section 131. Also, the CPU 11 acquires GPS data (N₀₁, E₀₁) to (N₄₂, E₄₂) of the lane marker lines constituting the lanes. Each of (N₀₁, E₀₁) to (N₄₂, E₄₂) means a pair of the latitude and the longitude.

If each piece of GPS data is accurate, and the GPS data of each lane marker line is data in consideration of, for example, curves of roads, (N₁₁, E₁₁)<(N_{c}, E_{c})<(N₂₂, E₂₂) is satisfied. Thus, the CPU 11 can estimate that the traveling lane of the host vehicle 1 is the second lane from the left side from the GPS data of the host vehicle 1 and the GPS data of each lane marker line constituting each lane.

Note that in a case in which the GPS data (N_{c}, E_{c}) representing the positional information of the host vehicle 1 is not accurate, the CPU 11 may correct the positional information using ground information. Also, the CPU 11 may correct the positional information depending on how the surrounding buildings, road signs, signals, front-side roads, and the like are seen from the camera 20.

Also, although the median strip and the lane marker lines are assumed to be solid lines as illustrated in FIGS. 5 and 7 in the present embodiment, the median strip or the lane marker lines may be dashed lines. In a case in which the median strip or the lane marker lines are dashed lines, the CPU 11 may additionally perform processing of connecting the dashed lines to regard the lane marker lines as a single solid line. Moreover, there may be a road in which lanes are sectioned by objects other than the lane marker lines, such as poles. In the case of the road in which lanes are sectioned by objects other than the lane marker lines, the CPU 11 may use GPS data indicating the positions of the objects. In a case of the road in which lanes are sectioned without lane marker lines, positional information of virtual center lines at both left and right ends of the road may be used as virtual GPS data.

The case in which the external parameter is GPS coordinates has been described hitherto, and a case in which the external parameter is a speed of the host vehicle will be briefly described. The CPU 11 calculates a change in distance between the host vehicle and the surrounding vehicle as a relative relationship between the host vehicle and the surrounding vehicle. The specific calculation method has been described in the second embodiment and will thus be omitted. The CPU 11 calculates a difference in speeds of the host vehicle and the surrounding vehicle using a difference in times at which two images used to calculate the change in the distance between the host vehicle and the surrounding vehicle are captured and the change in the distance. Then, the CPU 11 can also estimate the speed at which the surrounding vehicle is traveling by obtaining the sum of the speed of the host vehicle obtained to be used as an external parameter and the calculated difference in speed.

The CPU 11 may perform the calculation after converting the distance of the surrounding vehicle from the lane marker lines into latitude and longitude information in an actual space, instead of the distance using coordinates on the image data. Also, the CPU 11 may calculate the distance of the surrounding vehicle from the lane marker lines as specific numerical values using width information between the lane marker lines acquired from road network data or a dynamic map. In addition, the CPU 11 may calculate the distance of the surrounding vehicle from the lane marker lines by converting an image such that the angles of each lane marker line and the line segment from the horizontal line become 90 degrees through affine transform.

FIG. 8B is a flowchart illustrating details of the surrounding-vehicle condition estimation processing illustrated in Step S303 in FIG. 4C.

The CPU 11 acquires image data from the camera 20 (Step S321). The CPU 11 acquires information regarding the traveling lane of the host vehicle 1 from the vehicle condition storage section 132 in parallel with the acquisition of the image data from the camera 20 (Step S322). In the present embodiment, the CPU 11 acquires host-vehicle traveling lane information indicating that the host vehicle 1 is traveling through the second lane from the left side as illustrated in FIG. 7.

The CPU 11 detects the surrounding vehicle that is present in the image data using the image data acquired from the camera 20 (Step S323) and detects the lane marker lines that are present in the image data (Step S324). The CPU 11 clarifies regions of the surrounding vehicle and the lane marker lines that are present in the image data, on the image data.

FIG. 9A is a diagram illustrating an example in which the surrounding vehicle and the lane marker lines are detected from certain image data. The CPU 11 recognizes the positions of the median strip 41 and the lane marker lines 42a to 42d in the image data 50 illustrated in FIG. 9 from the left or right when viewed from the center line 51 of the image data 50. For example, the lane marker line 42b is located on the first lane on the left side when viewed from the center line 51, and the lane marker line 42a is located on the second lane on the left side when viewed from the center line 51. Thus, the host-vehicle traveling lane is between the lane marker line 42b and the median strip 41.

Also, the CPU 11 detects the surrounding vehicle 2 and a circumscribed rectangle 52 related to the shape of the surrounding vehicle 2 from the image data 50 illustrated in FIG. 9A.

When detecting the surrounding vehicle in the image data, the CPU 11 may use an object detection algorithm such as YOLO, for example. Note that in a case in which a plurality of surrounding vehicles 2 are captured in the image data, the CPU 11 detects regions where the surrounding vehicles 2 are captured for each of the surrounding vehicles 2.

Also, the CPU 11 may use a white line recognition system (see the 69th National Convention of IPSJ, “A New Lane Recognition Algorithm for Automotive Camera Images”, etc.), for example, or may use the aforementioned YOLO, machine learning, or the like to detect the lane marker lines in the image data.

Once the CPU 11 acquires the host-vehicle traveling lane information and detects the surrounding vehicle and the lane marker lines, then the CPU 11 estimates a condition of the detected surrounding vehicle (Step S325). The CPU 11 estimates, for example, a traveling direction, a traveling lane, or a speed of the surrounding vehicle as a condition of the surrounding vehicle. A method of estimating the condition of the surrounding vehicle is similar to that in the first embodiment or the second embodiment.

The CPU 11 similarly obtains angles of the median strip 41 and the lane marker lines 42a to 42d from the horizontal line in the image data 50. How to obtain the angles of the median strip 41 and the lane marker lines 42a to 42d from the horizontal line in the image data 50 is similar to that in the second embodiment.

Following Step S325, the CPU 11 inputs the surrounding-vehicle condition information that is information regarding the detected condition of the surrounding vehicle to the vehicle condition storage section 132 (Step S326).

Following Step S326, the CPU 11 outputs the surrounding-vehicle condition information to an external device (Step S327).

The CPU 11 can estimate the condition of the surrounding vehicle that is located around the host vehicle based on the image data and the GPS data by executing the series of processes without performing communication with the surrounding vehicle.

Modifications of the second embodiment and the third embodiment will be described.

The CPU 11 may estimate, from the image data, the distance from the lane marker lines of the lane on which the surrounding vehicle is traveling as the condition of the surrounding vehicle.

The CPU 11 can estimate how much margin from the lane marker lines the surrounding vehicle 2 is traveling, by estimating the distance of the surrounding vehicle from the lane marker lines.

The CPU 11 can also estimate whether the surrounding vehicle is in a parking or stopping condition from the distance between the surrounding vehicle and each lane marker line and the speed of the surrounding vehicle, for example, by merging the information of the condition of the surrounding vehicle estimated as described above.

In addition, the CPU 11 can also estimate whether the surrounding vehicle is traveling in the opposite direction by acquiring information including the number of lanes in the traveling direction and the opposite direction of the host vehicle from the road network, in addition to the lane on which the surrounding vehicle is moving and the traveling direction of the surrounding vehicle.

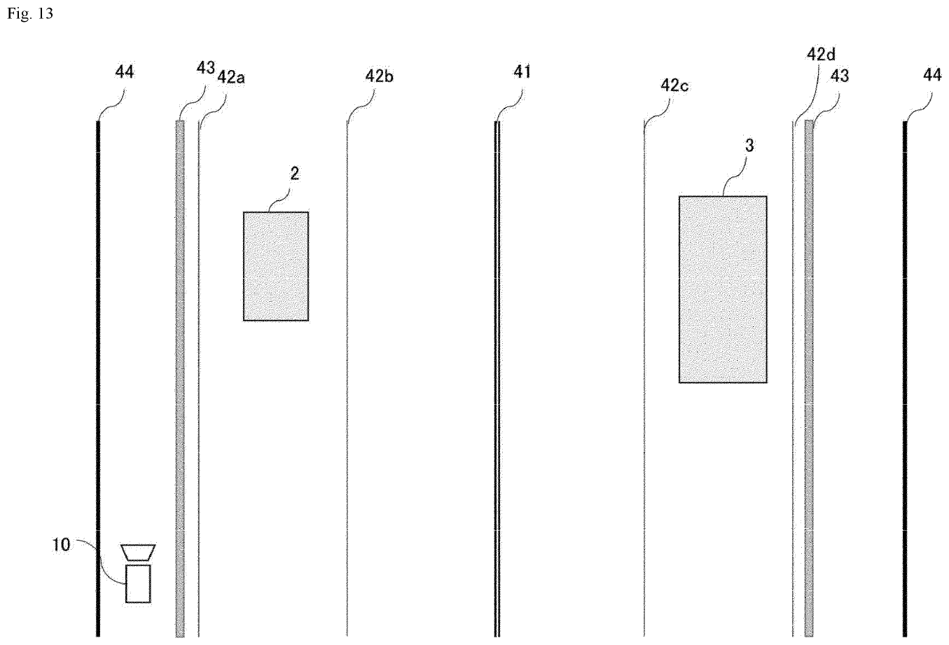

Although each embodiment described hitherto assumes that the image data is captured by the camera 20 mounted in the host vehicle 1, the present disclosure is not limited to such an example. Image data captured by a camera included in a mobile object other than a vehicle, such as a pedestrian or a bicycle, may be used as long as the range including the road region is imaged. FIG. 13 is a diagram illustrating a condition in which the vehicle condition estimation device 10 with a camera located at a position in a sidewalk images the range including the road region. As illustrated in FIG. 13, the vehicle condition estimation device 10 is not necessarily mounted inside the vehicle as long as the camera can image the range including the road region even if the camera is located at the sidewalk.

Although the case in which the traveling direction of the surrounding vehicle is the same as or opposite to the traveling direction of the host vehicle has been described in the aforementioned example, the vehicle condition estimation device 10 can apply the processing according to the present embodiment even in a case in which the traveling direction of the surrounding vehicle perpendicularly intersects the traveling direction of the host vehicle. Also, the vehicle condition estimation device 10 may recognize the “road region” in the image data using a semantic segmentation technique (example: http://mi.eng.cam.ac.uk/projects/segnet/), for example, and estimate that the surrounding vehicle is parking or stopping at a parking lot or the like regardless of the orientation of the surrounding vehicle as long as the vehicle is present outside the range of the “road region”.

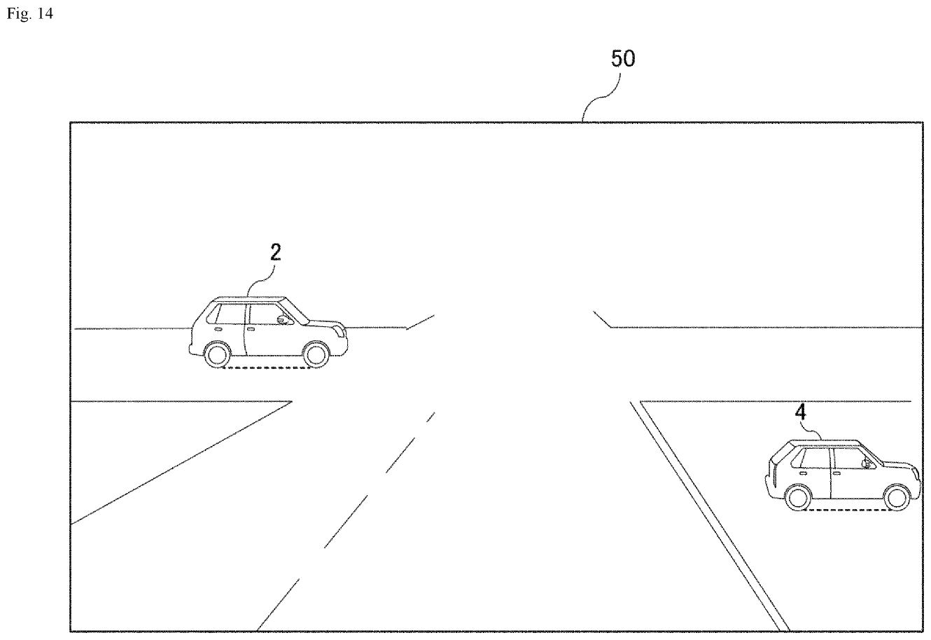

FIG. 14 is a diagram illustrating an example of image data. In the image data 50 illustrated in FIG. 14, surrounding vehicles 2 and 4 facing in the lateral direction are imaged. It is assumed that the surrounding vehicle 2 is traveling on the road while the surrounding vehicle 4 is parking or stopping at a parking lot on a side of the road instead of the road.

The CPU 11 can estimate the condition of a vehicle by calculating coordinates of lowermost portions of front wheels and rear wheels of the vehicle and a line segment connecting coordinates even in a case in which the image data 50 illustrated in FIG. 14 is obtained. In the example of the image in FIG. 14, the CPU 11 can estimate that the surrounding vehicle 2 is traveling in the direction that perpendicularly intersects the traveling direction of the host vehicle 1. Also, in the example of the image in FIG. 14, the CPU 11 can estimate that the surrounding vehicle 4 is in a parking or stopping condition because the surrounding vehicle 4 is not on the road.

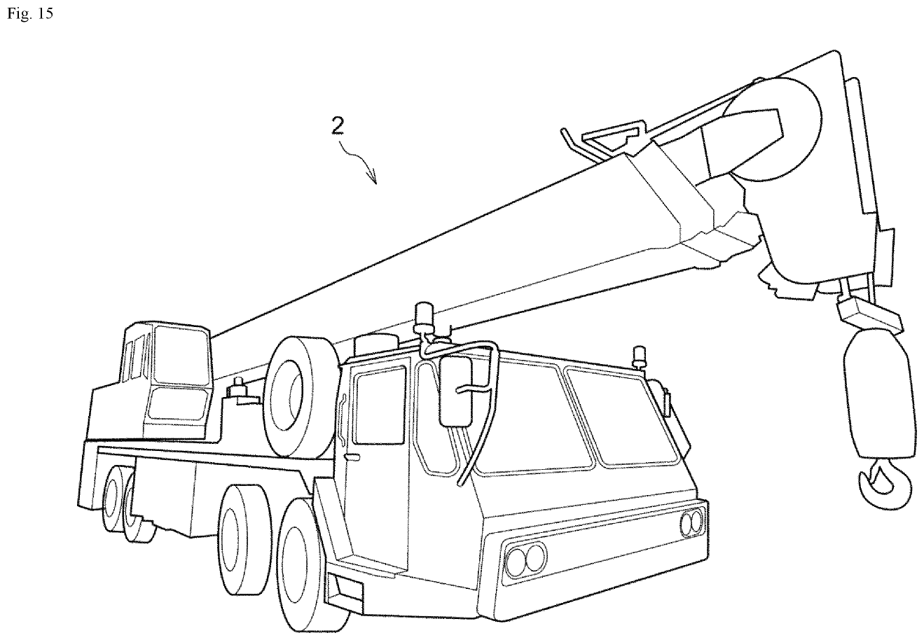

Although the vehicle condition estimation device 10 uses two coordinates of the front wheel and the rear wheel of the surrounding vehicle in each embodiment described hitherto, the present disclosure is not limited thereto. FIGS. 15 to 18 are diagrams illustrating special vehicles. The vehicle condition estimation device 10 can estimate the conditions of a vehicle by obtaining coordinates of the vehicle even in a case in which the special vehicles as illustrated in FIGS. 15 to 18 are imaged in the image data.

For example, some vehicles traveling with three or more wheels on each side like a large-sized vehicle illustrated in FIG. 15. In the case of the vehicle traveling with three or more wheels on each side, the vehicle condition estimation device 10 may use coordinates of all or a part of the three or more wheels. It is only necessary for the vehicle condition estimation device 10 to use coordinates of two wheels of a vehicle when the vehicle travels with only two wheels, such as a motorcycle. In a case of a vehicle with a spare tire mounted on the back thereof as illustrated in FIG. 16, for example, the vehicle condition estimation device 10 may recognize the back and ignore the spare tire on the back.

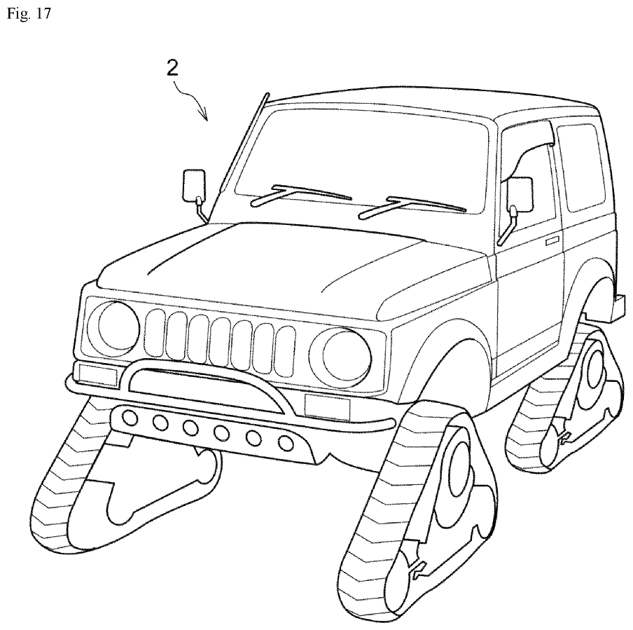

There is also a vehicle having tires with a special shape as illustrated in FIG. 17. In the case of the vehicle having tires with a special shape, the vehicle condition estimation device 10 is required to define that shapes of wheels are not only circular shapes but include substantially triangular shapes with arc-shaped apexes and recognize a front wheel and a rear wheel from the image data.

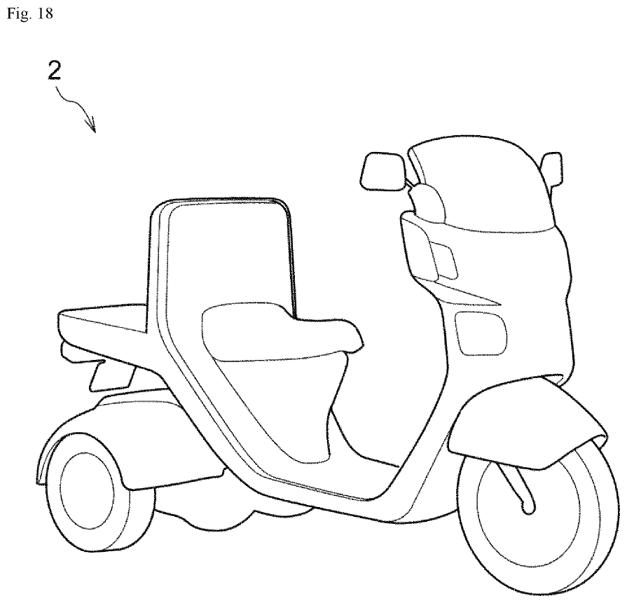

There is also a vehicle in which a line segment connecting the front wheel and the rear wheel does not conform to the traveling direction of the vehicle, like a three-wheel vehicle illustrated in FIG. 18. In the case of the vehicle in which the line segment connecting the front wheel and the rear wheel does not conform to the traveling direction of the vehicle, the vehicle condition estimation device 10 is required to label the vehicle as a “three-wheel vehicle” to classify it as a vehicle or a motorcycle with the label when the vehicle is detected by YOLO or the like and perform processing different from those for two-wheel vehicles and four-wheel vehicles. Then, in a case in which the vehicle condition estimation device 10 detects a vehicle as a three-wheel vehicle, the vehicle condition estimation device 10 may acquire a plurality of feature points of the rear wheels, calculate inclinations among the feature points, and use the calculated inclinations for estimation of a condition. Also, in the case of the three-wheel vehicle, the vehicle condition estimation device 10 may further detect sidesteps of the vehicle, a shadow of the vehicle on the ground surface, or the like instead of the wheels and use the detected coordinates.

Note that the vehicle condition estimation processing executed by the CPU reading software (program) in each of the aforementioned embodiments may be executed by various processors other than the CPU. Examples of the processor in such a case include a programmable logic device (PLD) such as a field-programmable gate array (FPGA) the circuit configuration of which can be changed after manufacturing, a dedicated electric circuit such as an application specific integrated circuit (ASIC) that is a processor having a circuit configuration designed dedicatedly for executing the specific processing, and the like. The vehicle condition estimation processing may be executed by one of these various processors or may be executed by a combination of two or more processors of the same type or different types (such as, for example, a plurality of FPGAs or a combination of a CPU and an FPGA). More specifically, the hardware structure of such various processors is an electrical circuit obtained by combining circuit devices such as semiconductor devices.

In each of the embodiments described above, an aspect has been described in which the vehicle condition estimation processing program is stored (installed) in advance in the storage 14, but the embodiments are not limited to this aspect. The program may be provided in the form of being stored in a non-transitory storage medium such as a compact disk read only memory (CD-ROM), a digital versatile disk read only memory (DVD-ROM), or a universal serial bus (USB) memory. The program may be in a form that is downloaded from an external device via a network.

With respect to the above embodiments, the following supplements are further disclosed.

Supplementary Item 1

A vehicle condition estimation device that estimates a position or a condition of a vehicle, the device comprising:
a memory; and
at least one processor connected to the memory,
wherein the processor is configured to
acquire an image including a vehicle to be estimated, and
estimate the position or the condition of the vehicle to be estimated, using a line segment connecting at least two points selected from a region in which the vehicle to be estimated is captured in the image, with reference to an imaging device that has captured the image.

Supplementary Item 2

A non-transitory storage medium that stores a computer-executable program to execute vehicle condition estimation processing for estimating a position or a condition of a vehicle, in which the vehicle condition estimation processing comprising:
acquiring an image that includes a vehicle to be estimated; and
estimating the position or the condition of the vehicle to be estimated, using a line segment connecting at least two points selected from a region in which the vehicle to be estimated has been captured in the image, with reference to an imaging device that has captured the image.

### REFERENCE SIGNS LIST

1 Host vehicle
2, 3, 4 Surrounding vehicle
41 Median strip
42a to 42d Lane marker line
43 Curbstone
44 Boundary
50, 50a, 50b Image data

1. A vehicle condition estimation method performed by an information processing device including a processor and a memory connected to the processor to estimate a position or a condition of a vehicle, the method comprising:
acquiring an image including a vehicle to be estimated; and
estimating the position or the condition of the vehicle to be estimated using a line segment connecting at least two points selected from a region in which the vehicle to be estimated is captured in the image, with reference to an imaging device that has captured the image.

2. The vehicle condition estimation method according to claim 1, wherein the condition includes at least any one of a traveling direction, a traveling lane, and a traveling speed of the vehicle to be estimated.

3. The vehicle condition estimation method according to claim 1, further comprising:
estimating a condition of the vehicle to be estimated by using information related to the imaging device that is not affected by a change in relationship between the vehicle to be estimated and the imaging device.

4. The vehicle condition estimation method according to claim 3, wherein the information related to the imaging device includes any one of a position of the imaging device and a road where the imaging device is located.

5. The vehicle condition estimation method according to claim 4, further comprising:
calculating, from a shape of the vehicle to be estimated, a line segment indicating a direction in which the vehicle to be estimated is traveling; and
estimating a lane on which the vehicle to be estimated is traveling, by determining in which lane the line segment is included.

6. The vehicle condition estimation method according to claim 5, further comprising:
recognizing a lane marker line indicating a lane from the image; and
estimating a lane on which the vehicle to be estimated is traveling, from a positional relationship between the line segment indicating a direction of the vehicle to be estimated and the lane marker line.

7. The vehicle condition estimation method according to claim 5, further comprising:
further recognizing a front wheel and a rear wheel of the vehicle to be estimated and calculating, as the direction, an angle formed by a line segment passing through the front wheel and the rear wheel in a direction from the rear wheel to the front wheel and a horizontal line; and
estimating, using the angle, a condition of the vehicle to be estimated.

8. The vehicle condition estimation method according to claim 7, further comprising:
calculating an angle formed between the lane marker line indicating a lane and the horizontal line from the image, and estimating, as the condition, a lane on which the vehicle to be estimated is traveling from a relationship between the angle of the line segment and the angle of the lane marker line from the horizontal line.

9. The vehicle condition estimation method according to claim 6, further comprising:
calculating a distance between the vehicle to be estimated and the lane marker line from a positional relationship between the line segment indicating the direction of the vehicle to be estimated and the lane marker lines.

10. A vehicle condition estimation device for estimating a position or a condition of a vehicle, the device comprising:
a memory; and
at least one processor connected to the memory,
wherein the processor is configured to
acquire an image including a vehicle to be estimated; and
estimate the position or the condition of the vehicle to be estimated using a line segment connecting at least two points selected from a region in which the vehicle to be estimated is captured in the image, with reference to an imaging device that has captured the image.

11. A non-transitory storage medium that stores a computer-executable program to execute vehicle condition estimation processing for estimating a position or a condition of a vehicle, in which the vehicle condition estimation processing comprises:
acquiring an image including a vehicle to be estimated; and
estimating the position or the condition of the vehicle to be estimated using a line segment connecting at least two points selected from a region in which the vehicle to be estimated is captured in the image, with reference to an imaging device that has captured the image.
